(19) United States
(12) Patent Application Publication
(10) Pub. No.: US 2023/0403625 A1
(43) Pub. Date: Dec. 14, 2023

(54) A DATA PACKET TRANSMISSION MECHANISM AND DEVICE

(71) Applicant: Samsung Electronics Co., Ltd., Gyeonggi-do (KR)

(72) Inventors: Weiwei WANG, Beijing (CN); Hong WANG, Beijing (CN); Lixiang XU, Beijing (CN)

(21) Appl. No.: 18/032,319

(22) PCT Filed: Oct. 15, 2021
(86) PCT No.: PCT/KR2021/014378

§ 371 Date: Apr. 17, 2023

(30) Foreign Application Priority Data
Oct. 16, 2020 (CN) 202011112835.8
Jan. 7, 2021 (CN) 202110019658.7

(51) Int. Cl. H04W 40/24; H04W 76/11; H04W 76/12; H04W 76/15

(52) U.S. Cl. CPC H04W 40/24; H04W 76/11; H04W 76/12; H04W 76/15

(57) ABSTRACT

The present disclosure relates to a pre-5th-Generation (5G) or 5G communication system to be provided for supporting higher data rates Beyond 4th-Generation (4G) communication system such as Long Term Evolution (LTE). The application relates to a packet transmission mechanism and device. With regard to the packet transmission mechanism, a scheme is provided to configure transmission configuration information of data with various attribute (or profile) at a relay node so that the relay node can transmit corresponding data in various ways according to the configured transmission configuration information.

### TECHNICAL FIELD

The application relates to wireless communication technology, and in particular, to a packet transmission mechanism and device.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

As the 5G network evolves, the base station may be composed of a central unit and a distributed unit. In addition, user data is transmitted through a user plane, and control data is transmitted through a control plane. In this case, when one relay is connected to different central units, the following problem may occur. First, it is impossible to complete configuration of separating the control plane data from the user plane data. Second, it does not consider how to transmit control plane data and user plane data of children nodes of the relay node is not considered.

### Solution to Problem

According to an aspect of an embodiment of the present application, there is provided a method performed by a first node in a communication system, comprising: receiving configuration information related to data transmission; and transmitting data of the first node and/or data of a fifth node according to the configuration information related to data transmission.

In an embodiment, the configuration information related to data transmission includes at least one of: indication information of data attribute (or profile), data transmission configuration information and data request information.

In an embodiment, the indication information of data attribute (or profile) includes at least one of: attribute (or profile) identification information, indication information of data type, indication information of belonging to the first node, indication information of belonging to the fifth node, indication information of a belonged node, indication information of a belonged route, indication information of a belonged destination receiving node, indication information of a belonged source sending node, indication information of a belonged transmission path, indication information of a used backhaul link channel, indication information of included information, wherein the data transmission configuration information includes at least one of: indication information of a cell group, indication information of a cell, indication information of a transmission method, indication information of a transmission network, indication information to use long term evolution (LTE) to transmit data, indication information to use fifth generation (5G) or new radio (NR) to transmit data, indication information to use radio resource control (RRC) or signaling radio bearer (SRB) to transmit data, indication information to use a backhaul link channel to transmit data, indication information to use master cell group (MCG) to transmit data, indication information to use secondary cell group (SCG) to transmit data, indication information related to a transmission route, indication information related to a transmission channel, information related to the transmission route to be added, indication information of the information to be removed. Further, the indication information to use radio resource control (RRC) or signaling radio bearer (SRB) to transmit data can also be used to indicate a type of a SRB for transmitting data, including SRB1, and/or SRB2, and/or SRB3, and/or a new SRB type, and wherein the data request information includes at least one of: identification information of a radio bearer; configuration information of user plane data carried by a radio bearer, including at least one of: information on a uplink tunnel, information on a downlink tunnel, source address information, destination address information, routing identification information and path identification information, information of a backhaul link channel used for transmitting the user plane data, including at least one of: identification information of a backhaul link channel used for sending the user plane data, identification information of a backhaul link channel used for receiving the user plane data.

In an embodiment, the transmitting data of the first node and/or data of a fifth node according to the configuration information related to data transmission, comprises: transmitting the data between the first node and the third node through a backhaul link channel or a RRC message or a SRB according to the configuration information related to data transmission, or transmitting the data between the first node and the third node via a fourth node according to the configuration information related to data transmission.

In an embodiment, the data is at least one of user plane data and control plane data.

In an embodiment, the radio bearer is a signaling radio bearer, and the user plane data is sent by using a new defined RRC message or by defining a new container in an existing RRC message, or the radio bearer is a data radio bearer or a new radio bearer.

According to another aspect of an embodiment of the present application, there is provided a method performed by a third node in a communication system, comprising: transmitting configuration information related to data transmission to a first node, transmitting data of the first node and/or data of a fifth node according to the configuration information related to data transmission.

In an embodiment, the configuration information related to data transmission includes at least one of: indication information of data attribute (or profile), data transmission configuration information and data request information.

In an embodiment, the indication information of data attribute (or profile) includes at least one of: attribute (or profile) identification information, indication information of data type, indication information of belonging to the first node, indication information of belonging to the fifth node, indication information of a belonged node, indication information of a belonged route, indication information of a belonged destination receiving node, indication information of a belonged source sending node, indication information of a belonged transmission path, indication information of a used backhaul link channel, indication information of included information, wherein the data transmission configuration information includes at least one of: indication information of a cell group, indication information of a cell, indication information of a transmission method, indication information of a transmission network, indication information to use LTE to transmit data, indication information to use 5G or NR to transmit data, indication information to use RRC or SRB to transmit data, indication information to use a backhaul link channel to transmit data, indication information to use MCG to transmit data, indication information to use SCG to transmit data, indication information related to a transmission route, indication information related to a transmission channel, information related to transmission route to be added, indication information of information to be removed. Further, the indication information to use RRC or SRB to transmit data can also be used to indicate the type of a SRB for transmitting data, including SRB1, and/or SRB2, and/or SRB3, and/or a new SRB type, and wherein the data request information includes at least one of: identification information of a radio bearer; configuration information of user plane data carried by a radio bearer, including at least one of: information on a uplink tunnel, information on a downlink tunnel, source address information, destination address information, routing identification information and path identification information; information of a backhaul link channel used for transmitting the user plane data, including at least one of: identification information of a backhaul link channel used for sending the user plane data and identification information of a backhaul link channel used for receiving the user plane data.

In an embodiment, the configuration information related to data transmission is configuration information for data of the first node or data of the fifth node.

In an embodiment, the method performed by the third node further comprises: sending, by the third node, a second request message, including configuration information related to data transmission for the first node, to a second node, and receiving, by the third node, a second response message from the second node including configuration information related to data transmission for the first node generated by the second node in response to the second request message, and the configuration information related to data transmission and transmitted to the first node is based on the second request message and/or the second response message; or sending, by the third node, a six request message to a fourth node, including at least one of configuration information related to data transmission for the first node, indication information indicating the fourth node to transmit data, indication information indicating the fourth node to transmit data of the first node, or indication information indicating the fourth node to transmit data of the fifth node, and receiving, by the third node, a six response message from the fourth node including configuration information related to data transmission for the first node generated by the fourth node in response to the six request message, and the configuration information related to data transmission sent to the first node is based on the sixth request message and/or the sixth response message.

In an embodiment, the method performed by the third node further comprises: receiving, by the third node, a fourth request message, including configuration information of the first node and/or configuration information related to data transmission of the first node, from the second node, and sending to the second node, by the third node, a fourth response message for configuration information related to data transmission for the first node generated in response to the fourth request message, and the configuration information related to data transmission sent to the first node is based on the fourth request message and/or the fourth response message; receiving, by the third node, an eighth request message including the configuration information related to data transmission of the first node from the fourth node, and sending, by the third node, an eighth response message for the configuration information related to data transmission for the first node generated in response to the eighth request message to the fourth node, and the configuration information related to data transmission sent to the first node is based on the eighth request message and/or the eighth response message.

In an embodiment, the method performed by the third node further comprises: receiving, by the third node, an eleventh request message from a fourth node, and sending an eleventh response message in response to the eleventh request message to the fourth node, and the configuration information related to data transmission sent to the first node is based on the eleventh request message or eleventh response message, wherein the eleventh request message includes one of: identification information of a radio bearer, configuration information of tunnels used for receiving user plane data by a fourth node side, and for each tunnel, the configuration information includes one of: an internet protocol (IP) address of the fourth node side, and a tunnel endpoint identifier, and wherein the eleventh response message includes one of: the identification information of a radio bearer, configuration information of tunnels used for receiving user plane data by a third node side, and for each tunnel, the configuration information includes one of: an internet protocol (IP) address of the third node side, and a tunnel endpoint identifier; indication information related to a transmission route including one of: routing identification information, backhaul adaptation protocol (BAP) address information, and path identification information; indication information related to a transmission channel including one of: identification information of a backhaul link channel used for sending the user plane data and identification information of a backhaul link channel used for receiving the user plane data.

In an embodiment, the radio bearer is a signaling radio bearer, and the user plane data is sent using a defined new RRC message or by defining a new container in an existing RRC message, or the radio bearer is a data radio bearer or a new radio bearer.

In an embodiment, the transmitting data of the first node and/or data of a fifth node according to the configuration information related to data transmission, comprises: performing, by the third node, user plane data transmission with the fourth node through a control message, wherein the control message includes at least one of: user plane data; indication information related to transmission route, including at least one of routing identification information, BAP address information and path identification information; indication information related to a transmission channel, including at least one of identification information of a backhaul link channel used for sending the user plane data and identification information of a backhaul link channel used for receiving the user plane data.

In an embodiment, the data is at least one of user plane data and control plane data.

In an embodiment, the transmitting data of the first node and/or data of a fifth node according to the configuration information related to data transmission, comprises: transmitting the data between the third node and the first node through a backhaul link channel or a RRC message or a SRB according to the configuration information related to data transmission, or transmitting the data between the third node and the first node via a fourth node according to the configuration information related to data transmission.

According to yet another aspect of an embodiment of the present application, there is provided a method performed by a fourth node in a communication system, comprising: acquiring configuration information related to data transmission; and transmitting data of the first node and/or data of a fifth node according to the configuration information related to data transmission.

In an embodiment, the configuration information related to data transmission includes at least one of: indication information of data attribute (or profile), data transmission configuration information and data request information.

In an embodiment, the indication information of data attribute (or profile) includes at least one of: attribute (or profile) identification information, indication information of data type, indication information of belonging to the first node, indication information of belonging to the fifth node, indication information of a belonged node, indication information of a belonged route, indication information of a belonged destination receiving node, indication information of a belonged source sending node, indication information of a belonged transmission path, indication information of a used backhaul link channel, indication information of included information. The data transmission configuration information includes at least one of: indication information of a cell group, indication information of a cell, indication information of a transmission method, indication information of a transmission network, indication information to use LTE to transmit data, indication information to use 5G or NR to transmit data, indication information to use RRC or SRB to transmit data, indication information to use a backhaul link channel to transmit data, indication information to use MCG to transmit data, indication information to use SCG to transmit data, indication information related to a transmission route, indication information related to a transmission channel, information related to transmission route to be added, indication information of information to be removed. Further, the indication information to use RRC or SRB to transmit data can also be used to indicate the type of a SRB for transmitting data, including SRB1, and/or SRB2, and/or SRB3, and/or a new SRB type, and wherein the data request information includes at least one of: identification information of a radio bearer; configuration information of user plane data carried by a radio bearer including at least one of: information on a uplink tunnel, information on a downlink tunnel, source address information, destination address information, routing identification information and path identification information; information of a backhaul link channel used for transmitting the user plane data by the first node, including at least one of: identification information of a backhaul link channel used for sending the user plane data and identification information of a backhaul link channel used for receiving the user plane data.

In an embodiment, the acquiring configuration information related to data transmission, comprises: receiving a sixth request message from a third node, wherein the sixth request message comprises one of: configuration information related to data transmission for the first node, indication information indicating a fourth node to transmit data, indication information indicating the fourth node to transmit data of the first node, or indication information indicating the fourth node to transmit data of a fifth node; and generating a sixth response message containing configuration information related to data transmission for the first node based on the sixth request message and sending it to the third node.

In an embodiment, the acquiring configuration information related to data transmission, comprises: sending, by the fourth node, an eighth request message including configuration information related to data transmission to the third node; and receiving, by the fourth node, an eighth response message including configuration information related to data transmission generated by the third node in response to the eighth request message from the third node.

In an embodiment, the method performed by the fourth node further comprises: transmitting, by the fourth node, the configuration information related to data transmission to the first node

According to yet another aspect of an embodiment of the present application, there is provided a method performed by a second node in a communication system, comprising: receiving, by a second node, a second request message from a third node including configuration information related to data transmission for a first node, and sending a second response message to the third node including configuration information related to data transmission for the first node generated in response to the received second request message.

In an embodiment, the configuration information related to data transmission includes at least one of: indication information of data attribute (or profile), and data transmission configuration information.

In an embodiment, the indication information of data attribute (or profile) includes at least one of: attribute (or profile) identification information, indication information of data type, indication information of belonging to the first node, indication information of belonging to the fifth node, indication information of a belonged node, indication information of a belonged route, indication information of a belonged destination receiving node, indication information of a belonged source sending node, indication information of a belonged transmission path, indication information of a used backhaul link channel, indication information of included information, wherein the data transmission configuration information includes at least one of: indication information of a cell group, indication information of a cell, indication information of a transmission method, indication information of a transmission network, indication information to use LTE to transmit data, indication information to use 5G or NR to transmit data, indication information to use RRC or SRB to transmit data, indication information to use a backhaul link channel to transmit data, indication information to use MCG to transmit data, indication information to use SCG to transmit data, indication information related to a transmission route, indication information related to a transmission channel, information related to transmission route to be added, indication information of information to be removed. Further, the indication information to use RRC or SRB to transmit data can also be used to indicate the type of a SRB for transmitting data, including SRB1, and/or SRB2, and/or SRB3, and/or a new SRB type.

According to yet another aspect of the present disclosure, there is provided a first node in a communication system, comprising: a transceiver configured to receive and transmit signals; a memory configured to store data; and a processor coupled to the memory and configured to perform the methods of the first node according to embodiments of the present disclosure.

According to yet another aspect of the present disclosure, there is provided a third node in a communication system, comprising: a transceiver configured to receive and transmit signals; a memory configured to store data; and a processor coupled to the memory and configured to perform the methods of the third node according to embodiments of the present disclosure.

According to yet another aspect of the present disclosure, there is provided a fourth node in a communication system, comprising: a transceiver configured to receive and transmit signals; a memory configured to store data; and a processor coupled to the memory and configured to perform the methods of the fourth node according to embodiments of the present disclosure.

According to yet another aspect of the present disclosure, there is provided a second node in a communication system, comprising: a transceiver configured to receive and transmit signals; a memory configured to store data; and a processor coupled to the memory and configured to perform the methods of the second node according to embodiments of the present disclosure.

### Advantageous Effects of Invention

According to the present disclosure, packet data can be smoothly transmitted when the 5G network and relay are mixed.

### BRIEF DESCRIPTION OF DRAWINGS

FIG. 1 is an exemplary system architecture of system architecture evolution (SAE);

FIG. 2 is an exemplary system architecture according to various embodiments of the present disclosure;

FIG. 3 is a schematic diagram of a multi-hop network architecture;

FIG. 4 is a scenario example of data transmission;

FIG. 5 is an example method of data transmission according to an embodiment of the present application;

FIG. 6 is yet another example method of data transmission according to an embodiment of the present application;

FIG. 7 is an example diagram of a configuration flow of data transmission according to an embodiment of the present application;

FIG. 8 is another example diagram of a configuration flow of data transmission according to an embodiment of the present application;

FIG. 9 is another example diagram of a configuration flow of data transmission according to an embodiment of the present application;

FIG. 10 is an example diagram of a configuration flow of user plane data transmission according to an embodiment of the present application;

FIG. 11 is another example diagram of a configuration flow of user plane data transmission according to an embodiment of the present application;

FIG. 12 illustrates a simplified block diagram of an example configuration of hardware components of a communication device 1200 according to various embodiments of the present disclosure.

FIG. 13 illustrates a simplified block diagram of an example configuration of hardware components of a communication device 1300 according to various embodiments of the present disclosure.

FIG. 14 illustrates a simplified block diagram of an example configuration of hardware components of a communication device 1400 according to various embodiments of the present disclosure.

FIG. 15 illustrates a simplified block diagram of an example configuration of hardware components of a communication device 1500 according to various embodiments of the present disclosure.

### MODE FOR THE INVENTION

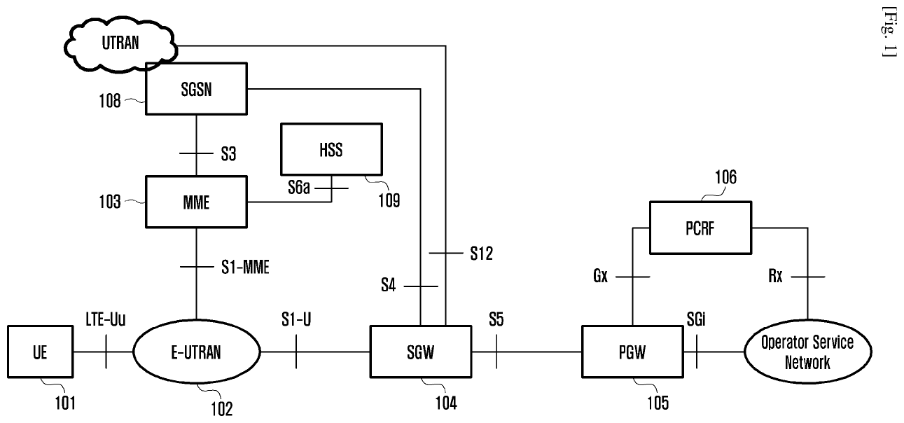

FIGS. 1 to 15 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS)109 is a home subsystem of the UE, and is responsible for protecting user information including a current location of the user equipment, an address of a serving node, user security information, and packet data context of the user equipment, etc.

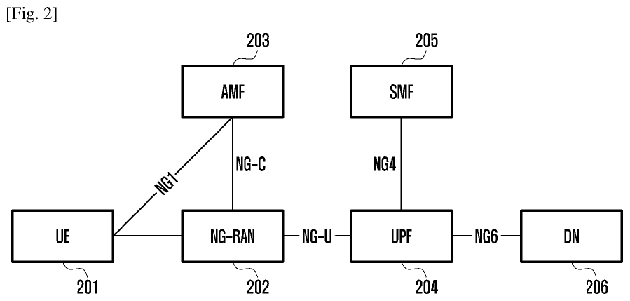

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

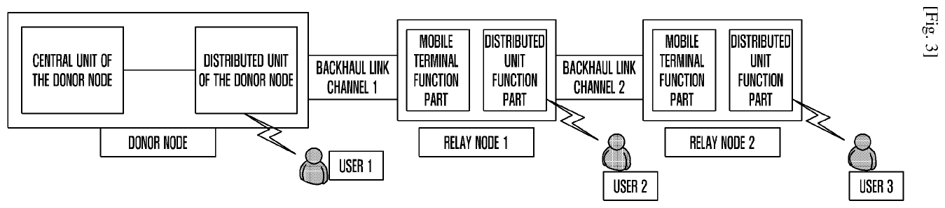

In New Radio (NR) network, in order to expand the network coverage, a relay network architecture, IAB (Integrated Access and Backhaul), is proposed. FIG. 3 illustrates a schematic architecture of a multi-hop relay network (IAB network), which illustrates a network architecture including an donor node (such as IAB donor/anchor) and two relay nodes (such as IAB node). Users in the multi-hop network can access the network through an donor node or a distributed unit of the donor node or the relay nodes, for example, users 1, 2, and 3 access the relay network through the distributed unit of donor node, a distributed unit part of a relay node 1, and a distributed unit part of a relay node 2, respectively. The donor node may be an independent base station or a base station composed of a central unit (CU) (an IAB-donor central unit) and a distributed unit (DU) (an IAB-donor distributed unit). The relay node includes a mobile terminal function and a distributed unit function (in another example, it can also be described that the relay node includes a mobile terminal function part and a distributed unit function part), herein, the mobile terminal function part of the relay node is used to communicate with an upper level node of the relay node (for example, a mobile terminal part of the relay node 1 is used to communicate with the donor node or the distributed unit of the donor node, and a mobile terminal part of the relay node 2 is used to communicate with the distributed unit part of the relay node 1), the distributed unit function part of the relay node is used to communicate with a lower level node of the relay node (for example, the distributed unit part of the relay node 1 is used to communicate with the user 2, and can also be used to communicate with the mobile terminal part of the relay node 2). The mobile terminal part of the relay node can be regarded as a user accessing the network, so it has functions of an normal user (an non-relay node) (for example, the mobile terminal part can establish signaling radio bears (SRB) with its upper level node to send a RRC message, and can also establish data radio bears (DRB) to send data). Protocol stacks included in the central unit of the donor node include: protocol stacks serving the control plane, which include a radio resource control (RRC) protocol layer and a packet data convergence protocol (PDCP) layer; and protocol stacks serving the user plane, which include a service data adaptation protocol (SDAP) layer and a PDCP layer. Protocol stacks included in the distributed unit of the donor node or the distributed unit part of the relay node include: protocol stacks serving the control plane and user plane, which include a radio link control (RLC) protocol layer, a medium access control (MAC) protocol layer and a physical layer (PHY). Interfaces between the central unit of the donor node and the distributed unit of the donor node, and between the central unit of the donor node and the distributed unit of the relay node are F1 interfaces (see 3GPP TS38.473, the entire contents of which are incorporated herein by reference).

In the relay network, links between the relay node and the donor node or the distributed unit of the donor node or between the relay nodes are backhaul links, on which one or more different backhaul channels can be established, for example, backhaul link channel 1 and backhaul link channel 2, as shown in FIG. 3. A non-limiting example of a backhaul link channel is a backhaul link radio link control (RLC) protocol layer channel, that is, a Backhaul RLC channel. In the relay network, each backhaul link channel can be used to send packets belonging to the same user or different users. The packets may be packets of a data radio bearer (DRB) of a user, or may be packets of a signaling radio bearer (SRB) of a user, or may be packets of a control plane on F1 interfaces, or may be packets of a user plane on F1 interfaces, or may be packets of non-F1 interfaces (such as IPSec packets, packets of SCTP protocols, packets of an OAM, etc.).

In order to realize transmission of user data in multi-hop relay network, 3GPP defines a new protocol layer, namely, a backhaul adaptation protocol layer (BAP layer), which will be configured in the distributed unit of the donor node and the relay nodes (such as the mobile terminal part of the relay nodes and/or the distributed unit part of the relay nodes), above a RLC layer, and main functions of which are routing of packets and mapping of packets. In order to transmit user data between the relay nodes and the donor node, configuration of the backhaul links and configuration of the F1 interfaces between the distributed unit part of the relay nodes and the donor node need to be completed. These configurations include but are not limited to the following types, such as BAP addresses, route configuration (such as routing identification information indicating different transmission routes, including BAP address of a destination receiving node and path identification), configuration of a backhaul link channel, configuration of tunnels, backhaul link configuration for tunnels, etc.

In the relay network, between the central unit of the donor node and the distributed unit functional part of the relay node, an F1 interface can be established, on which control plane data (such as data traffic of F1-C) and user plane data (such as data traffic of F1-U) need to be transmitted. When the relay node is in a single connectivity mode (that is, the relay node only keeps connection with one base station, and at this time the base station is a donor node), data traffic of F1-C and F1-U need to be transmitted through a link between the donor node and the relay node. However, when the relay node is in a dual connectivity mode (that is, the relay node keeps connection with two base stations, at least one of which is a donor node), data traffic of F1-C and F1-U can be transmitted through the two base stations.

In the current research, control plane data traffic and user plane data traffic between the relay node and the donor node may be transmitted by the same transmission path, or by the same network technology, or by the same base station in the case of dual connectivity. However, in the actual system, data traffic in the control plane needs higher reliability and lower delay, but data traffic in the user plane needs faster rate, so existing transmission methods may lead to a performance loss of the data traffic in the control plane (such as a decrease in reliability and an increase in delay, etc.).

In addition, when the relay node is in a dual connectivity, a primary secondary cell (PScell) serving the relay node may change, and during this process, data communication between the relay node and the secondary base station may be interrupted. This will interrupt data transmission of users served by the relay node.

For transmission of control plane data traffic and user plane data traffic, one solution is to transmit the control plane data and user plane data of the relay node separately, such as, by two different base stations for transmission. However, this solution still has the following problems: 1. it is impossible to complete configuration of separating the control plane data from the user plane data; 2. how to transmit control plane data and user plane data of children nodes of the relay node is not considered.

One aspect of solutions of the present application is to complete configuration of data transmission through signaling interaction between the relay node and one or more base stations to which the relay node connected, so as to realize the transmission of data on the relay node and children nodes to which the relay node is connected.

There is no solution in the prior art to the problem of data interruption when the PSCell serving the relay node changes. To this end, one aspect of solutions of the present application is to reduce interruption of data transmission by transmitting user data through a master node to which the relay node is connected.

It should be understood that in the description of the present application, the message names are only examples, and other message names can also be used. In addition, “first” and “second” included in the message names in the description of the present application are only examples of message names, which are used to distinguish one message from another, and do not represent the execution order, nor imply any relationship between messages. In addition, the steps including response messages (such as a second response message, a fourth response message, a sixth response message, an eighth response message, and a eleventh response message) may be mandatory or optional.

In addition, in order to avoid obscuring main points of the present application, detailed descriptions of steps unrelated to the main points of the present application are omitted in the present application.

Furthermore, in the present application, expressions of “the mobile terminal function of the relay node” and “the mobile terminal part of the relay node” are used interchangeably, and expressions of “the distributed unit function of the relay node” and “the distributed unit part of the relay node” are used interchangeably.

Before further starting the detailed description of the present application, it is beneficial to clarify the meanings of various terms involved in the following detailed description, among which meanings of some terms are described as follows:

In the present application, the control plane data includes at least one of:
F1-C data, i.e. control plane data on F1 interface (interface between a central unit and a distributed unit of a base station, interfaces between a central unit of a donor node and a distributed unit of a donor node, or interface between a central unit of the donor node and a distributed unit functional part of the relay node),
data carried by a SRB, such as data containing a RRC message,
Xn-C data, i.e. control plane data on Xn interface (interface between gNBs),
X2 data, that is, control plane data on X2 interface (interface between a LTE eNB and a gNB).

In an embodiment, the control plane data may be IP packets (which contain at least one of IP header, SCTP header, PDCP PDU and F1AP/RRC/XnAP/X2AP messages); In another embodiment, the control plane data may be BAP packets (which contain at least one of BAP header, IP header, SCTP header, PDCP header and F1AP/RRC/XnAP/X2AP messages); In another embodiment, the control plane data may be PDCP PDUs; In another embodiment, the control plane data may be F1AP/RRC/XnAP/X2AP messages.

In the present application, the user plane data can be at least one of:
F1-U data, that is, user plane data on F1 interfaces;
data carried by DRBs, that is, user plane data on radio air interfaces;
Xn-U data, i.e. user plane data on Xn interfaces;
X2-U data, that is, user plane data on X2 interfaces;
In an embodiment, the user plane data may be IP packets (which contain at least one of IP header, GTP-U header and PDCP PDU); In another embodiment, the user plane data may be BAP packets carrying data (which contain at least one of BAP header, IP header, GTP-U header and PDCP PDU); In another embodiment, the user plane data may be PDCP PDUs.

In the present application, without explicit explanation, the mentioned “data” can be control plane data, or can be user plane data, or can be control plane data and user plane data. Throughout the entire description of the present application, “transmission of data” refers to receiving and/or sending of data.

In the present application, the BAP header of the packets includes at least one of:
address information of the destination receiving node, such as BAP address,
path identification information, such as path ID,
routing identification information, such as BAP routing ID, which includes a BAP address of the destination receiving node and path identification information,
flow control feedback information, such as backhaul link channel identification information, available buffer size information for one backhaul link channel, routing identification information, available buffer size information for one routing identification, etc.
flow control polling information (flow control polling),
backhaul link failure information (Backhaul RLF Indication),

See 3GPP TS38.340 for details of specific content in the BAP header, and the entire contents are incorporated herein by reference.

Nodes mainly involved in the present application are as follows:
A first node: a first relay node, or a distributed unit function part of the first relay node, or a mobile terminal function part of the first relay node, or a normal user, or a distributed unit of a base station.
A second node: an upper level node of the first node (parent node, ascendant node), which can be a donor node, or a distributed unit of the donor node, or other relay nodes (a second relay node), or a distributed unit functional part of the other relay nodes or a mobile terminal functional part of the other relay nodes, or a base station, or a distributed unit of the base station.
A third node: a first base station serving the first node (or a central unit of the first base station, or a control plane part of the central unit of the first base station), which may be a 5G base station, or may be a 4G base station, or may be other types of network entities. In one embodiment, the node may be a first donor node serving the first node (or a central unit of the first donor node, a control plane part of the central unit part of the first donor node, or a user plane part of the central unit part of the first donor node), which is a node supporting the relay network; in another embodiment, the node may be a base station that does not support the relay network (or a central unit of the base station, a control plane part of the central unit part of the base station, or a user plane part of the central unit part of the base station).
A fourth node: a second base station serving the first node (or a central unit of the base station, a control plane part of the central unit of the base station, or a user plane part of the central unit of the base station), which is a base station different from the third node; the base station may be a 5G base station, or may be a 4G base station, or may be other types of network entities. In an embodiment, the node can be an donor node different from the third node, that is, a second donor node serving the first node (or a central unit of the second donor node, or a control plane part of the central unit part of the second donor node, or a user plane part of the central unit of the second donor node), which is a node supporting relay network functions. In another embodiment, the node may be a base station (or a central unit of the base station, a control plane part of the central unit of the base station, or a user plane part of the central unit of the base station) different from the third node, and the base station is a node that supports partial relay network functions or does not support relay network functions.

Further, when the first node establishes dual connection, the first node can establish dual connection with the third node and the fourth node, and the first node establishes an interface with the third node (e.g., an F1 interface). In an embodiment, the third node is a master node and the fourth node is a secondary node; in another embodiment, the third node is a secondary node and the fourth node is a master node.
A fifth node: a node different from the first node, which may be one or more other relay nodes. In an embodiment, the fifth node is a node (a child node, such as a child node, a descendant node) directly or indirectly connected with the first node (indirect connection means connecting with the first node through one or more intermediate nodes), and the fifth node needs to carry out communicate in the network through the first node.

The definition and description of “data configuration information” involved in the detailed description of the present application are as follows:

Data configuration information: information used to configure data transmission (i.e., sending and/or receiving) at a first node. The data can be data of the first node (or a distributed unit function part of the first node), or can be data of a fifth node accessing the first node (or a distributed unit function part of the fifth node), and the fifth node is different from the first node and can be a distributed unit of other relay nodes or other base stations. In an embodiment, the fifth node is a node directly or indirectly connected with the first node (indirect connection means connecting with the first node through one or more intermediate nodes), which needs to communicate with the third node or the fourth node through the first node. The receiving node of the configuration information can be one or more of the above-mentioned first/second/third/fourth/fifth nodes, and the specific flow can be seen in the following description.

Information contained in the data configuration information is configuration information related to data transmission, which includes at least one of:
Indication information of data attribute (or profile), which is used to indicate information related to the transmitted data. After receiving the indication information, the receiving node will transmit data indicated by the indication information according to one or more of the following “data transmission configuration information” (such as one or more of the following “indication information of a cell group”, “indication information of a cell”, “indication information of a transmission method” and “indication information of a transmission network”) corresponding to the indication information. The indication information of data attribute (or profile) includes at least one of:
attribute (or profile) identification information, such as index information,
indication information of data type, the function of which is to indicate whether the data is control plane data or user plane data,
indication information of belonging to the first node, which indicates that data transmitted by a first node is data belonging to the first node,
indication information of belonging to the fifth node or indication information of belonging to a non-first node, which indicates that the data transmitted by the first node is data belonging to other nodes except the first node,
indication information of a belonged node, which is used to indicate identification information of one or more nodes to which the data transmitted by the first node belongs, such as node IDs, BAP addresses, gNB-DU IDs, etc.,
indication information of a belonged route, which is used to indicate identification information of one or more routes to which the data transmitted by the first node belongs, such as BAP routing IDs (including BAP addresses of the destination receiving node and path identification information),
indication information of a belonged destination receiving node, which indicates identification information of one or more destination receiving nodes to which the data transmitted by the first node belongs, such as BAP addresses, IP addresses, etc. Further, the indication information may also include port information, etc.,
indication information of a belonged source sending node, which indicates identification information of one or more source sending nodes to which the data transmitted by the first node belongs, such as BAP addresses, IP addresses, etc. Further, the indication information may also include port information, etc.,
indication information of a belonged transmission path, which indicates identification information of one or more transmission paths to which the data transmitted by the first node belongs, such as path IDs,
indication information of a used backhaul link channel, which indicates identification information of one or more backhaul link channels used by the data transmitted (received or sent) by the first node. A backhaul link channel may be a channel used by the first node to receive data (for example, Ingress BH RLC CH), and may further include identification information of a prior-hop node serving the backhaul link channel, for example, BAP addresses, and/or channels used for sending data (e.g., Egress BH RLC CH), and further may include identification information of a next-hop node serving the backhaul link channel, for example, BAP addresses,
indication information of included information, if the data contains information indicated by the indication information, the first node performs data transmission according to the corresponding configuration information contained in the following corresponding “data transmission configuration information”. The indication information may indicate that the included information is at least one of:
IP address information,
Port information,
Source IP address information,
Source port information,
Destination IP address information,
Destination port information,
Routing identification information, such as a BAP routing ID. In an embodiment, the identification information includes the BAP addresses of the destination receiving node and path ID,
BAP address information. In one embodiment, the address information can be address information of the destination receiving node, in another embodiment, the address information can be address information of the source sending node,
Path identification information, such as a path ID.
Data transmission configuration information, which is used to configure transmission of data with various attribute (or profile). For example, data with a certain attribute (or profile) may correspond to one kind of data transmission configuration information, and data with another attribute (or profile) may correspond to another kind of data transmission configuration information. In one embodiment, the data transmission configuration information may be configuration information for transmitting control plane data (such as F1-C data traffic), in another embodiment, the data transmission configuration information may be configuration information for transmitting user plane data (such as F1-U data traffic), and in another embodiment, the data transmission configuration information may be configuration information used for transmitting data indicated by the above-mentioned “indication information of data attribute (or profile)”. The data transmission configuration information includes at least one of:
indication information of a cell group, which is used to indicate information of the cell group used for data transmission, and the cell group is the cell group serving the first node. The cell group indicated by the information may be at least one of:
a master cell group (MCG), then the first node can transmit data using the master cell group. The master cell group is a cell group served by a master base station, which can be a master base station in a dual-connectivity service mode or a master base station in a multi-connectivity service mode,
a secondary cell group (SCG), then the first node can use the secondary cell group to transmit data. The secondary cell group is a cell group served by a secondary base station, which can be a secondary base station in a dual-connectivity service mode or a secondary base station in a multi-connectivity service mode,
a master cell group and a secondary cell group, then the first node can use the master cell group and secondary cell group to transmit data. In one embodiment, an indication information can be used to indicate that the primary cell group and the secondary cell group can be used to transmit data at the same time, such as “both”.
identification information of a cell group, such as Cell Group ID, is used to indicate identification information of one or more cell groups for transmitting data. In an embodiment, the identification information of the cell group may include identification of one or more cell groups, or may indicate one or more cell groups by a bitmap (that is, in a bit string, a position of each bit corresponds to one cell group, and a value of each bit represents whether the corresponding cell group is used for data transmission, such as “1” for data transmission, “0” for data non-transmission, or vice versa).
indication information of a cell, which is used to indicate the cell used for data transmission, and the cell is a cell serving the first node. In an embodiment, the indication information may include identification of one or more cells, or may indicate one or more cells by a bitmap (i.e., in a bit string, a position of each bit corresponds to a cell, and a value of each bit represents whether the corresponding cell is used for data transmission, such as “1” for transmitting data, “0” for not transmitting data; or “1” for not transmitting data, “0” for transmitting data.
indication information of a transmission method, which is used to indicate a transmission mode of the data, and the indicated transmission mode includes at least one of:
using a RRC message (or a signaling radio bearer (SRB)) to transmit data, and the indication information indicates whether the first node can use a RRC message (or a SRB) to transmit data (such as indicating that a RRC message (or a SRB) can be used, or indicating that a RRC message (or a SRB) cannot be used). A RRC message may be a RRC message of LTE (a RRC message defined in 3GPP TS36.331) or may be a RRC message of 5G NR (New Radio) (a RRC message defined in 3GPP TS38.331). Further, the indication information can also be used to indicate the type of a RRC message for transmitting data, such as a RRC message of LTE and/or the RRC message of 5G NR (such as, indicating that a RRC message of LTE and/or a RRC message of 5G NR can be used, or indicating that a RRC message of LTE and/or a RRC message of 5G NR cannot be used), and the indication information can also be used to indicate the type of a SRB for transmitting data, such as SRB1, SRB2, SRB3, and/or a new SRB type etc.
using a backhaul link channel to transmit data, and the indication information indicates that the first node can transmit data using the configured backhaul link channel. The indication information may be a way of explicit indication or a way of implicit indication. In an embodiment, after the first node is configured with a backhaul link channel for transmitting data (such as transmitting control plane data, or transmitting user plane data, or transmitting control plane data and user plane data), it can be explicitly indicated whether the configured backhaul link channel need to be used to transmit data. In another embodiment, it may be implicitly determined whether to use the backhaul link to transmit data according to whether a backhaul link channel (and/or route information, which may be routing identification information, such as BAP routing ID) is configured for transmitting data, for example, if configured, it implicitly indicates that the configured backhaul link need to be used to transmit data; If not configured, it implicitly indicates that data cannot be transmitted using the backhaul link,
using a RRC message (a SRB) and a backhaul link channel to transmit data, then it indicates that the first node can transmit data using the above-mentioned RRC message (SRB) and backhaul link channel. In an embodiment, the method for transmitting data (i.e., the method for transmitting data using a RRC message (or a SRB) and a backhaul link channel) can be indicated by indication information (e.g., “both” indicates that data is transmitted using a RRC message (or a SRB) and a backhaul link channel). In another embodiment, the method for transmitting data can be indicated by a plurality of indication information, for example, by indication information of “transmitting data using a RRC message (or a SRB)” to indicate that it can be transmitted by a RRC message (or a SRB), and by configuring a backhaul link channel for transmitting data to implicitly indicate that it can be transmitted by using a backhaul link channel.
indication information of a transmission network, which is used to indicate a network used for transmitting data, and the network is a network serving the first node. The network indicated by the indication information includes at least one of:
LTE network, then the “indication information of a transmission network” indicates that the first node can use the LTE network to transmit data,
5G (or NR) network, then the “indication information of a transmission network” indicates that the first node can use the 5G (or NR) network to transmit data,
LTE and 5G (or NR) networks, then the “indication information of a transmission network” indicates that the first node can use LTE and 5G (or NR) to transmit data. In an embodiment, the network for transmitting data can be indicated by indication information (for example, “both” indicates that data can be transmitted through LTE and 5G (or NR)).

In an embodiment, the transmission path indication information of F1-C (e.g., f1c-TransferPath) can be used to represent the above-mentioned “indication information of a transmission network”, and the network indicated by the information can be LTE, NR, or both (i.e., LTE and NR)>
indication information to use LTE to transmit data, which is used to indicate whether to transmit data using the LTE network. In one embodiment, the information can be used to indicate whether to use the LTE network to transmit control plane data (such as F1-C data). In one example, the information can be named as “f1c-via-LTE”. If the information is indicated as “true”, it means that the control plane data can be transmitted by the LTE network; otherwise (if the indication information is not included or is indicated as “false”), it means that the control plane data cannot be transmitted by the LTE network. In another embodiment, the information can be used to indicate whether to use the LTE network to transmit user plane data (such as F1-U data). In one example, the information can be named as “flu-via-LTE”. If the information is indicated as “true”, it means that the user plane data can be transmitted by the LTE network; otherwise (if the indication information is not included or is indicated as “false”), it means that the user plane data cannot be transmitted by the LTE network. In another embodiment, the information may be used to indicate whether the LTE network is used to transmit the control plane data (such as F1-C data) and the user plane data (such as F1-U data). After receiving this information, a receiving node can know whether the LTE network can be used to transmit data. Further, the receiving node may determine a network for transmitting data according to other configurations. For example, if a backhaul link channel for transmitting data is configured at the receiving node, the NR network can be used for transmitting data by default, and the indication information is used to indicate whether the LTE network can also be used for transmitting data.
indication information to use 5G or NR to transmit data, which is used to indicate whether to use 5G (or NR) network to transmit data. After receiving this information, a receiving node can know whether the 5G (or NR) network can be used to transmit data,
indication information to use RRC (or SRB) to transmit data, which is used to indicate whether to use RRC (or SRB) to transmit data. After receiving this information, a receiving node can know whether RRC (or SRB) can be used to transmit data. Further, the indication information can also be used to indicate the type of a SRB for transmitting data, such as SRB1, SRB2, SRB3, and/or a new SRB type etc.
indication information to use a backhaul link channel to transmit data, which is used to indicate whether to use a backhaul link channel to transmit data. After receiving this information, a receiving node can know whether a backhaul link channel can be used to transmit data,
indication information to use MCG to transmit data, functions of which are used to indicate whether to use MCG to transmit data. After receiving this information, a receiving node can know whether the MCG can be used to transmit data,
indication information to use SCG to transmit data, which is used to indicate whether SCG is used to transmit data. After receiving this information, the receiving node can know whether SCG can be used to transmit data,
indication information related to a transmission route, which includes at least one of:
routing identification information, which indicates routing identification used to transmit data, such as BAP routing ID. For example, the routing identification contains a BAP address of a destination receiving node and path identification information,
BAP address information, which is the BAP address of the destination receiving node of data,
Path identification information, which is a path used to send data to the destination receiving node.
indication information related to a transmission channel, which includes at least one of:
identification information of a backhaul link channel used for sending data, such as Egress BH RLC CH ID, which may be identification information of one or more channels. After receiving this information, the first node will use this channel to send data, and further, it may also include identification information of a next-hop node serving the backhaul link channel, such as BAP addresses.
identification information of a backhaul link channel used for receiving data, such as Ingress BH RLC CH ID, which may be identification information of one or more channels, and further may include identification information of a prior-hop node serving the backhaul link channel, such as a BAP address.
Information related to the transmission route to be added, which indicates information that the node needs to add for the received packet. The information includes at least one of:
routing identification information, which indicates routing identification used to transmit data, such as BAP routing ID. For example, the routing identification contains the BAP address of a destination receiving node and path identification information,
BAP address information, which is the BAP address of the destination receiving node of data,
Path identification information, the path is a path used to send data to the destination receiving node.

In an embodiment, after receiving the “information related to the transmission route to be added”, after receiving the packet, the first node will add the information to the packet before sending it out.
indication information of information to be removed, which indicates information that the node needs to remove before sending the received packet. This information includes at least one of:
routing identification information, which indicates routing identification used to transmit data, such as BAP routing ID. For example, the routing identification contains the BAP address of a destination receiving node and path identification information,
BAP address information, which is the BAP address of the destination receiving node of data,
Path identification information, the path is a path used to send data to the destination receiving node.

In an embodiment, after receiving the “indication information of the information to be removed”, after receiving the packet, the first node will remove information indicated by the indication information contained in the packet before sending it out.
data request information, which can help to determine configuration of the transmitted user plane data, and the information includes at least one of:
identification information of a radio bearer;
configuration information of user plane data carried by a radio bearer, which includes at least one of:
information on a uplink tunnel, which includes at least one of an IP address of a third node side and a tunnel endpoint identifier,
information on a downlink tunnel, which includes at least one of an IP address of a first node side and a tunnel endpoint identifier,
source address information, such as an IP address and/or a BAP address, etc.,
destination address information, such as an IP address and/or a BAP address, etc.,
routing identification information, such as a BAP routing ID, in one embodiment, it includes the BAP address of a destination receiving node and path identification information,
path identification information, such as a path ID
information on a backhaul link channel used for user plane data, the backhaul link channel is a backhaul link channel used by the first node to transmit the user plane data, and the information includes at least one of:
identification information of a backhaul link channel used for sending the user plane data, such as Egress BH RLC CH ID, which may be identification information of one or more channels, and may further include identification information of a next-hop node serving the backhaul link channel such as a BAP address.
identification information of a backhaul link channel used for receiving the user plane data, such as Ingress BH RLC CH ID, which may be identification information of one or more channels, and may further include identification information of a prior-hop node serving the backhaul link channel, such as a BAP address.

Further, the above-mentioned “data transmission configuration information” can be given for data with different attribute (or profile) indicated by different “indication information of data attribute (or profile)”.

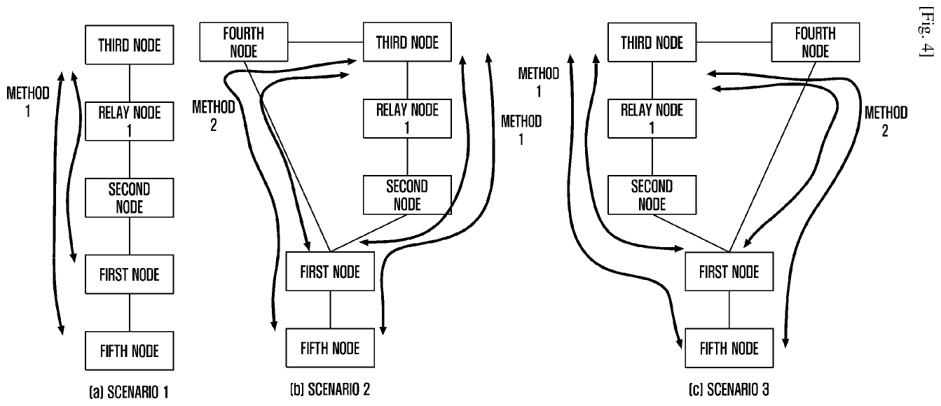

Throughout the description of the present application, three scenarios shown in FIG. 4 are mainly involved:

Scenario 1

A first node is in a single connection mode. An F1 interface is established between the first node and a third node.

Scenario 2

The first node is in a dual connectivity mode. An F1 interface is established between the first node and the third node. The third node serves as a secondary base station, and a fourth node serves as a master base station.

Scenario 3:

The first node is in a dual connectivity mode. An F1 interface is established between the first node and the third node. The third node serves as a master base station, and the fourth node serves as a secondary base station.

It should be understood that the above scenarios are only examples, and the scenarios to which the present application can be applied are not limited thereto. In addition, the number of relay nodes between the third node and the first node is only an example, and the number of child nodes to which the first node is connected is only an example, which can also be other numbers, and is not limited to the illustrated number. There may be other nodes between the first node and a fifth node. Therefore, the scheme of the present application is not limited to the scenario shown in FIG. 2, and the present application is still applicable to other scenarios.

Next, the application will be described from three aspects: transmission of data, configuration of data transmission of relay nodes, and transmission of user plane data during a process of PSCell changing.

The First Aspect: Transmission of Data

This aspect gives an example process for transmitting data between the third node (or the fourth node) and the first node. The first node can perform data transmission with the third node according to a single connectivity mode, as shown in FIG. 4(a), or can perform data transmission with the third node (or the fourth node) according to a dual-connectivity mode, as shown in FIGS. 4(b) and 4(c). The data can be data transmitted on an interface (such as an F1 interface) between the first node (or a distributed unit function part of the first node) and the third node, or can be data transmitted on an interface (such as an F1 interface) between the fifth node (or a distributed unit function part of the fifth node) accessing the first node and the third node.

It should be understood that when data transmission is performed at the first node, the communication system has been configured for data transmission at relevant nodes in the network, and the configuration process will be described later in the second aspect. As it has been configured at relevant nodes in the network, referring to the above description of “data configuration information”, it can be known that, since “data transmission configuration information” can be given for data with different attribute (or profile), The nodes can know information about data attribute (or profile) according to ways of receiving data. The details will be explained in detail in the description of the second aspect. Here, firstly, data transmission processes between nodes after configuration will be described.

Specifically, as shown in FIG. 4, at least one of the following data transmission methods may be included.
Method 1: data is transmitted through a backhaul link channel and/or a RRC message (or a SRB) between the first node and the third node.

In this method, as shown in FIG. 4, the backhaul link channel is a backhaul link channel established between the first node and its upper level node (such as the second node), and the RRC message is the RRC message of the first node (or a mobile terminal functional part of the first node). The SRB may be SRB1, and/or SRB2, and/or SRB3, and/or a new SRB type, etc.

In this method, transmission of downlink data includes the following steps, as shown in FIG. 5(a):

In step 1-1-a1: the third node sends a first downlink message to the first node, which is sent by the third node directly or indirectly (via one or more intermediate nodes) to the first node. The message is used to send data to the first node, and the message may be sent to the first node through a backhaul link channel and/or a RRC message (or a SRB). The first downlink message includes at least one of the following:
data of the first node, which includes at least one of:
control plane data between the first node and the third node,
user plane data between the first node and the third node,
data including an F1AP message, which is the F1-C interface control message sent by the third node to the first node, further, the data may also include at least one of a SCTP header and an IP header,
data carrying non-F1AP messages on the F1-C interface (such as non-F1 data), the F1-C interface is the interface between the first node and the third node. Further, the data can also include at least one of a SCTP header and an IP header,
data of the fifth node, which includes at least one of:
identification information of included data, such as index information, which is used to help identify attribute (or profile) of the included data, such as the belonged routing identification, indication of the belonged destination receiving node, etc. For specific attribute (or profile), please refer to the “indication information of data attribute (or profile)” contained in the above-mentioned “data configuration information”. Through the identification information, the first node receiving the data can know that the data is to be further sent to the fifth node or that the data is from the fifth node.
control plane data between the fifth node and the third node,
user plane data between the fifth node and the third node,
data containing a F1AP message, the F1AP message is an F1-C interface control message sent by the third node to the fifth node. Further, the data can also include at least one of BAP header, SCTP header and IP header,
data (such as non-F1 data) carrying a non-F1AP message on an F1-C interface, which is an interface between the fifth node and the third node. Further, the data can also include at least one of BAP header, SCTP header and IP header,
indication information related to a transmission route, which includes at least one of:
routing identification information, which indicates routing identification used for data transmission, such as a BAP routing ID, which contains a BAP address of the destination receiving node and path identification information,
BAP address information, which is the BAP address of the destination receiving node of data,
Path identification information, which is a path used to send data to the destination receiving node,

In one embodiment, after receiving the information, the first node will add the “indication information related to a transmission route” to the received packet (the packet contains the above-mentioned “data of a fifth node”, in one embodiment, the packet is the above-mentioned first downlink message) before sending it out. Further, the packet may be a packet containing the data of the fifth node.
indication information related to a transmission channel, which includes at least one of:
identification information of a backhaul link channel used for sending data, such as Egress BH RLC CH ID, which may be identification information of one or more channels that will be used by the first node to send the data out after receiving this information, and the identification information may further include identification information of a next-hop node serving a backhaul link channel such as BAP addresses,
identification information of a backhaul link channel used for receiving data, such as Ingress BH RLC CH ID, which may be identification information of one or more channels, and further may include identification information of a prior-hop node serving a backhaul link channel, such as BAP addresses.

In an embodiment, the first node will transfer the received packet to a backhaul link channel indicated by the “indication information related to a transmission channel” for sending.

In step 1-1-a2, the first node processes the received first downlink message. In an embodiment, if the received first downlink message contains the data of the first node, the first node processes it and will not send it out again or send it to the user accessing the first node. In another embodiment, if the received first downlink message contains the data of the fifth node, the first node sends it out. Further, information can be added to it and then sending it out. The added information can be the “indication information related to a transmission route” contained in the above step 1-1-a1, or can also be pre-configured information (in one embodiment, the pre-configured information can refer to the above “data configuration information”, such as the “information related to transmission routes to be added” contained in the above “data configuration information”).

In the method 1, transmission of uplink data includes the following steps, as shown in FIG. 5(b):

In step 1-1-b1, the first node sends a first uplink message to the third node, which is sent by the first node directly or indirectly (via one or more intermediate nodes) to the third node. The message is used to send data to the third node. The message may be sent through a backhaul link channel or a RRC message (or a SRB). The message includes at least one of:
data of the first node, which includes at least one of:
control plane data between the first node and the third node,
user plane data between the first node and the third node,
data including an F1AP message, which is an F1-C interface control message sent by the first node to the third node, further, the data may also include at least one of SCTP header and IP header,
data (such as non-Ft data) carrying a non-F1AP message on the F1-C interface, which is the interface between the first node and the third node. Further, the data can also include at least one of SCTP header and IP header,
data of the fifth node, which includes at least one of:
control plane data between the fifth node and the third node,
user plane data between the fifth node and the third node,
data including an F1AP message, which is the F1-C interface control message sent by the fifth node to the third node, further, the data may also include at least one of BAP header, SCTP header and IP header,
data (such as non-F1 data) carrying a non-F1AP message on the F1-C interface, which is the interface between the fifth node and the third node. Further, the data can also include at least one of BAP header, SCTP header and IP header.

Optionally, before step 1-1-b1, step 1-1-b0 may also be included: the first node processes the received data, which may be sent to the first node by the fifth node, and may include the data of the fifth node, which includes at least one of:
control plane data between the fifth node and the third node,
user plane data between the fifth node and the third node,
data including an F1AP message, which is the F1-C interface control message sent by the fifth node to the third node, further, the data may also include at least one of BAP header, SCTP header and IP header,
data (such as non-F1 data) carrying a non-F1AP message on the F1-C interface, which is the interface between the fifth node and the third node. Further, the data can also include at least one of BAP header, SCTP header and IP header.

Further, after receiving the data sent by the fifth node, optionally, the first node can remove a part of information in the data according to the configuration (for the configuration, one can refer to the above-mentioned “data configuration information”, for example, the “indication information of information to be removed” contained in the above-mentioned “data configuration information”) and then send it out, and the removed information includes at least one of:
routing identification information, which indicates routing identification used for data transmission, such as a BAP routing ID, the routing identification contains a BAP address of the destination receiving node and path identification information,
BAP address information, which is the BAP address of the destination receiving node of data,
Path identification information, which is a path used to send data to the destination receiving node.

Further, the first node will determine the data for which it needs to process in the above manner (i.e., remove a part of information in the data) according to the configuration (see the above-mentioned “data configuration information”, such as the above-mentioned “indication information related to the transmission channels” contained in the above-mentioned “data configuration information”). As a non-limiting example, for example, the first node may determine that data received through the configured backhaul link channel needs to be processed in the above manner, because attribute (or profile) information corresponding to the data received through the configured backhaul link channel is data of the fifth node, and transmission configuration information corresponding to the attribute (or profile) includes “indication information of information to be removed”.

In the above step 1-1-a1 and/or step 1-1-b1, the first downlink message and/or the first uplink message may be sent only through a backhaul link channel established between the first node and its upper level node (such as the second node), or may be sent only through a RRC message (or a SRB) of the first node, or may be sent not only through a backhaul link channel established between the first node and its upper level node (such as the second node) but also through a RRC message (or a SRB) of the first node, according to the choice of the first node or the third node.

In the above process, if packets are sent through a RRC message (or a SRB), the first downlink message can be a RRC message, such as DLInformationTransfer, or other messages. The first uplink message may be a RRC message, such as ULInformationTransfer, or other messages. In addition, the SRB carrying the first downlink message and/or the first uplink message may be SRB1, and/or SRB2, and/or SRB3, and/or a new SRB type.

For the method 1, in one embodiment, the first node may be in a single connectivity mode, that is, the first node only establishes a connection with the third node; in another embodiment, the first node may be in a dual connectivity mode, that is, the first node has established a connection with the fourth node in addition to with the third node, and then the third node and the fourth node may be a master node and a secondary node, respectively or a secondary node and a master node, respectively. The above method 1 gives a method of data transmission between the third node and the first node, in which data can be transmitted using a RRC message (or a SRB) and/or a backhaul link channel according to configuration at the node, and the data does not pass through the fourth node.

The method 1 can achieve at least the following effects: the first node (relay node) can send and/or receive user plane data and/or control plane data of itself and its child nodes to or from the third node (donor node) through an independent RRC message (or a SRB) or a backhaul link channel according to appropriate configuration, thus avoiding mixing transmission of the control plane and the user plane data, thereby improving the reliability of the control plane data and reducing the delay of control plane data transmission, and also increasing the throughput of the user plane data transmission.

For a scenario where the first node is in a dual connectivity or multi-connectivity, the following method 2 can be adopted to perform data transmission with the third node. It should be understood that although the following description is directed to the case where the first node is connected to the third node and the fourth node, the following method 2 can be similarly applied to a case where the first node is connected to a larger number of base stations.

Method 2: data is transmitted between a first node and a third node through a fourth node.

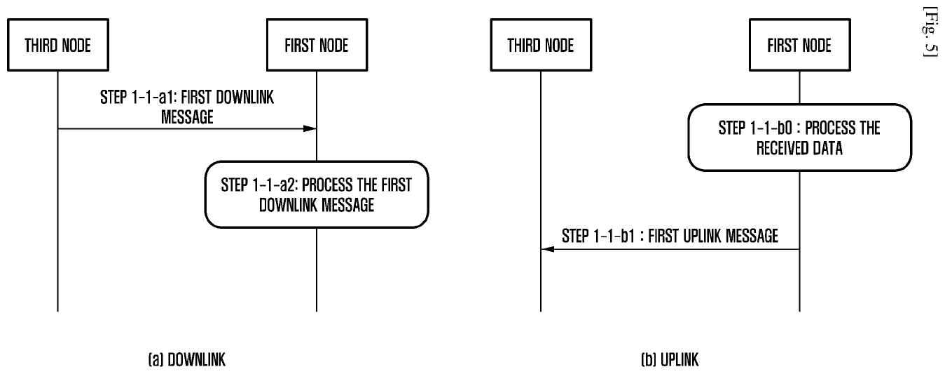

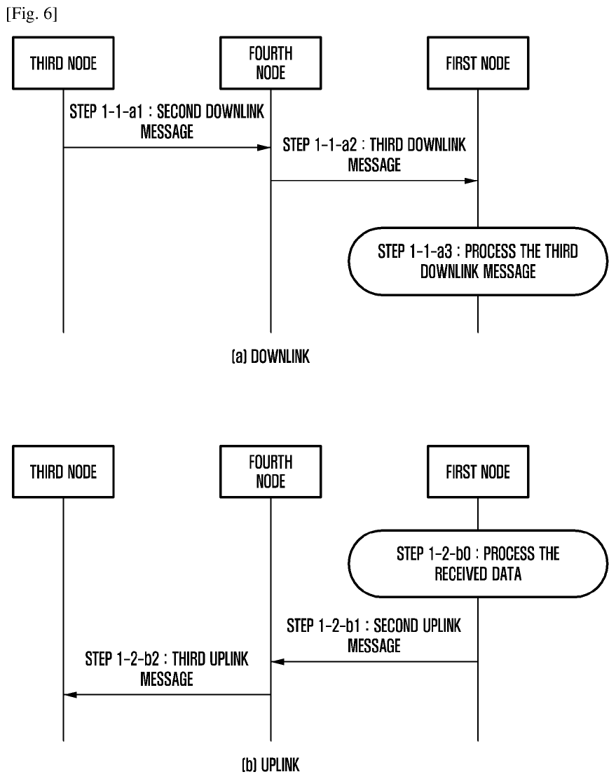

In the method 2, the transmission of downlink data includes the following steps, as shown in FIG. 6(a):

In step 1-2-a1, the third node sends a second downlink message to the fourth node. For the information contained in the message, one can refer to the first downlink message in the above step 1-1-a1. The second downlink message can be an XnAP or X2AP message, such as an F1-C Service Transfer message, an F1-U Service Transfer message or other messages.

In step 1-2-a2, the fourth node sends a third downlink message to the first node. For the information contained in the message, one can refer to the first downlink message in the above step 1-1-a1. The third downlink message can be a RRC message (or a SRB), such as a DLInformationTransfer message, or other messages. In addition, the SRB carrying the third downlink message may be SRB1, and/or SRB2, and/or SRB3, and/or a new SRB type.

In step 1-2-a3, the first node processes the received third downlink message, and for the processing method, one can refer to the above step 1-1-a2.

In the method 2, transmission of uplink data includes the following steps, as shown in FIG. 6(b):

In step 1-2-b1, the first node sends a second uplink message to the fourth node. For the information contained in the message, one can refer to the first uplink message in the above step 1-1-b1. The second uplink message can be a RRC message (or a SRB), such as an ULInformationTransfer message, or other messages. In addition, the SRB carrying the third uplink message may be SRB1, and/or SRB2, and/or SRB3, and/or a new SRB type.

In step 1-2-b2, the fourth node sends a third uplink message to the third node. For the information contained in the message, one can refer to the first uplink message in the above step 1-1-b1. The third downlink message can be an XnAP or X2AP message, such as an F1-C Traffic Transfer message, an F1-U Traffic Transfer message or other messages.

Optionally, before step 1-2-b1, it may also include step 1-2-b0: the first node processes the received data according to transmission configuration information corresponding to the received data, which may be sent by the fifth node to the first node, and for the information contained in the data, one may refer to description of the information contained in the data in the above step 1-1-b0.

Technical effects that can be achieved by the above method 2 at least include: the first node (e.g., relay node) can send user plane data and/or control plane data of itself and its child nodes to an donor node to which it connects through other base stations according to configuration, or receive data of the donor node to which it connects through the other base stations. In this way, transmission paths of control plane data can be separated from transmission paths of user plane data by performing proper transmission configuration on data with various attribute (or profile), thereby improving the reliability of data transmission and reducing the delay of data transmission.
Method 3: data can be transmitted either through a backhaul link channel and/or a RRC message (or a SRB) or through the fourth node between the first node and the third node.

This method is a combination of Method 1 and Method 2, and for the specific contents, one can refer to Method 1 and Method 2, respectively. It is up to the first node or the third node to decide whether the first node adopts the method 1 or the method 2 to perform transmission of data, and it can be realized by appropriately configuring the transmission configuration information of data with corresponding attribute (or profile).

The above three methods can be used for only transmitting control plane data, or can also be used for only transmitting user plane data, or can also be used for transmission of both the control plane data and user plane data at the same time.

As a non-limiting example, for example, by configuring the control plane data of the first node and the user plane data of the fifth node with different transmission configuration information, respectively, the control plane data of the first node can be configured to be transmitted between the first node and the third node through another base station (fourth base station) to which the first node connects, while the user plane data of the fifth node can be configured to be transmitted between the first node and the third node through a backhaul link channel.

The above method can achieve at least the following effects: transmission paths of the data of the first node (e.g., relay node) itself and the data of its child nodes can be determined by flexible selection and appropriate transmission configuration (e.g., transmitting through other base stations to which the first node connects, or transmitting through a backhaul link channel with the donor node and/or a RRC message (or a SRB)), thereby improving the reliability of the control plane data, reducing the delay of the control plane data transmission and increasing the throughput of the user plane data transmission.

The Second Aspect: Configuration of Data Transmission of a Relay Node

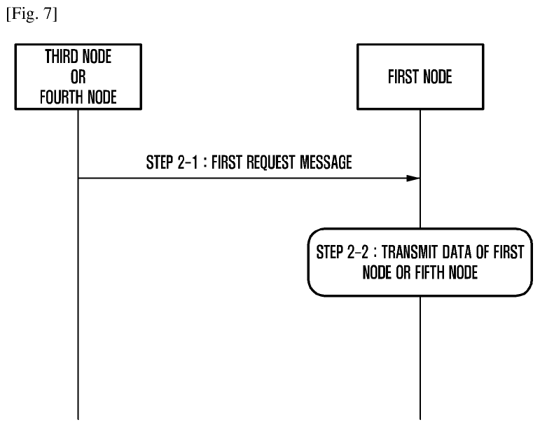

Configuration of the data transmission of the relay node involves a signaling interaction process between the third node (or the fourth node) and the first node. The process may include the third node (or the fourth node) sending configuration information related to data transmission to the first node directly or indirectly (through one or more intermediate nodes). The process includes the following steps, as shown in FIG. 7:

In step 2-1, the third node (or the fourth node) sends a first request message to the first node, which is used to configure the first node to perform transmission (sending and/or receiving) of data. The first configuration message includes at least one of:
configuration information for transmitting data of the first node, the data is the data of the first node, such as data to be transmitted by a distributed unit functional part of the first node. For the contents contained in the configuration information, one can refer to the above-mentioned “data configuration information”, and all the contents contained therein are for the data of the first node.
configuration information for transmitting data of the fifth node, the data is the data of the fifth node, such as data to be transmitted by a distributed unit functional part of the fifth node. For the contents contained in the configuration information, one can refer to the above-mentioned “data configuration information”, and all the contents contained therein are for the data of the fifth node.

In an embodiment, the “configuration information for transmitting data of the fifth node” may include the above-mentioned “indication information of data attribute (or profile)” and/or the above-mentioned “data transmission configuration information”; in another embodiment, the configuration information may only contain the above-mentioned “indication information of data attribute (or profile)”, and the configuration information for transmitting data of the fifth node may adopt the “data transmission configuration information” contained in the above-mentioned “configuration information for transmitting data of the first node”, in other words, the data of the fifth node may be transmitted with the same transmission configuration as that of the first node.

In step 2-2, the first node performs transmission (receiving or sending) of the data of the first node or the fifth node according to the configuration information received in step 2-1. In an embodiment, the first node may transmit data in a single connectivity mode, that is, data transmission is performed between the first node and the third node; in another embodiment, the first node may transmit data in a dual connectivity mode, that is, the first node maintains a connection with the fourth node in addition to the third node, and the transmitted data is data on an interface between the first node and the third node (such as signalings of an F1-C interface, data of an F1-U interface). For the data transmission method in this step, one may refer to Method 1, Method 2 and/or Method 3 in the first aspect of the present application.

In the above process, the first request message can be a RRC message (such as a RRCReconfiguration message) (or a SRB, such as SRB1, and/or SRB2, and/or SRB3, and/or a new SRB type, etc.), or can be an F1AP message, or can be other types of messages.

The above process can be used only for configuring transmission of control plane data, or can be used only for configuring transmission of user plane data, or can be used for configuring transmission of both the control plane data and the user plane data.

Advantageous effects that can be achieved by the above process include: the first node can transmit its own data and/or data of child nodes to which it connects according to the configuration information, and different transmission configurations can be adopted for different data by appropriate configuration.

In some embodiments, when configuring the first node for data transmission, it may also include the process of signaling interaction between the third node and the parent node (such as the second node) to which the first node connects, which is mainly for configuring the data transmission of the first node at the second node. The method of realizing the configuration process includes the following methods.
Method 1: configuration initiated by the third node

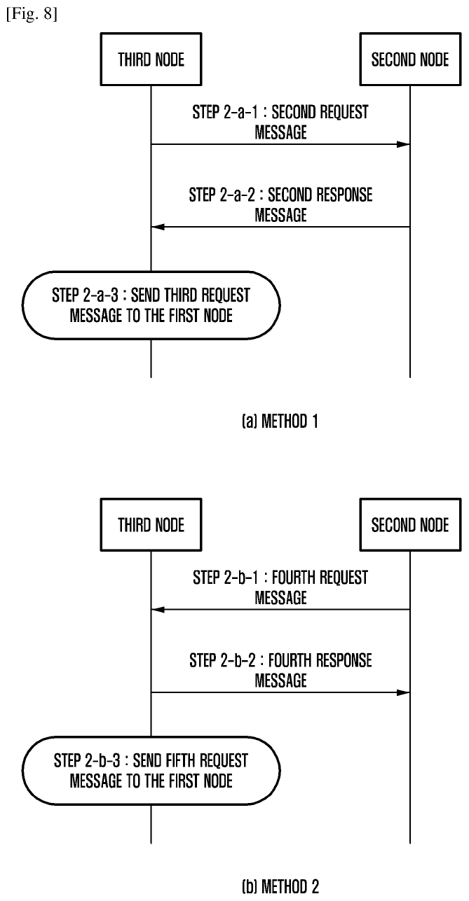

The Method 1 includes the following steps, as shown in FIG. 8(a):

In step 2-a-1, the third node sends a second request message to the second node, the message is used to configure the second node to perform transmission of the data of the first node (which may be data of the first node itself, data of the fifth node, the data of the first node itself and the data of the fifth node). The message may include at least one of the following information:
indication information of data attribute (or profile),
data transmission configuration information, in one embodiment, the data transmission configuration information may be configuration information for transmitting control plane data (such as F1-C data traffic), in another embodiment, the data transmission configuration information may be configuration information for transmitting user plane data (such as F1-U data traffic), and in another embodiment, the data transmission configuration information may be configuration information used for transmitting data indicated by the above-mentioned “indication information of data attribute (or profile)”. The information includes at least one of:
indication information of a cell group, such as MCG, SCG, MCG and SCG (“both” can be used to indicate that both MCG and SCG can be used to transmit data),
indication information of a cell,
indication information of a transmission method, such as a RRC message (or a SRB), a backhaul link channel, a RRC message (or a SRB) and a backhaul link channel (“both” can be used to indicate that both a RRC message (or a SRB) and a backhaul link channel can be used to transmit data),
indication information of a transmission network, such as LTE network, 5G (or NR) network, LTE and 5G (or NR) network (“both” can be used to indicate that both LTE and 5G networks can be used to transmit data). In an embodiment, the transmission path indication information of F1-C (e.g., f1c-TransferPath) can be used to represent the above-mentioned “indication information of a transmission network”, and the network indicated by the information can be LTE, NR, or both (i.e., LTE and NR)
indication information to use LTE to transmit data;
indication information to use 5G or NR to transmit data;
indication information to use RRC (or SRB) to transmit data;
indication information to use a backhaul link channel to transmit data;
indication information to use MCG to transmit data;
indication information to use SCG to transmit data;

For the specific contents of the above-mentioned “indication information of data attribute (or profile)” and “data transmission configuration information”, one can refer to the above-mentioned “data configuration information”.

In step 2-a-2, the second node sends a second response message to the third node, and the function of the message includes at least one of the following functions: confirming receipt of the first request message in step 2-a-1; configuring the second node to perform transmission of the data of the first node, and sending the configuration information related to data transmission for the first node generated by the second node (such as CellGroupConfig information in TS38.331).

Optionally, in step 2-a-3: the third node sends a third request message to the first node, or the third node sends a third request message to the first node through the fourth node, which is used to configure the first node to transmit data. For the content of the request message, one can refer to the first request message in the above step 2-1.

In the above process, the second request message and the second response message can be F1AP messages (such as a UE Context Setup/Modification Request message and a UE Context Setup/Modification Response message) or other messages.

The process in above Method 1 can be used only for configuring transmission of control plane data (such as F1-C data), or can be used only for configuring transmission of user plane data, or can be used for configuring both transmission of the control plane data (such as F1-C data) and the user plane data.

Advantageous effects that can be achieved by the method 1 includes: by using the configuration information related to data transmission for the first node sent by the second node, actual situations of each related node can be better satisfied when the third node configures the data transmission of the first node.
Method 2: configuration initiated by the second node

The Method 2 includes the following steps, as shown in FIG. 8(b):

In step 2-b-1, the second node sends a fourth request message to the third node, the function of which is to notify the third node of configuration information on transmitting the data of the first node (which may be data of the first node itself, data of the fifth node, the data of the first node itself and the data of the fifth node). The message may include at least one of the following information:
indication information of data attribute (or profile),
The data transmission configuration information which includes at least one of:
indication information of a cell group, such as MCG, SCG, MCG and SCG (“both” can be used to indicate that both MCG and SCG can be used to transmit data),
indication information of a cell,
indication information of a transmission method, such as a RRC message (or a SRB), a backhaul link channel, a RRC message (or a SRB) and a backhaul link channel (“both” can be used to indicate that both a RRC message (or a SRB) and a backhaul link channel can be used to transmit data),
indication information of a transmission network, such as LTE network, 5G (or NR) network, LTE and 5G (or NR) network (“both” can be used to indicate that both LTE and 5G networks can be used to transmit data). In an embodiment, the transmission path indication information of F1-C (e.g., f1c-TransferPath) can be used to represent the above-mentioned “indication information of a transmission network”, and the network indicated by the information can be LTE, NR, or both (i.e., LTE and NR)
indication information to use LTE to transmit data;
indication information to use 5G or NR to transmit data;
indication information to use RRC or SRB to transmit data;
indication information to use a backhaul link channel to transmit data;
indication information to use MCG to transmit data;
indication information to use SCG to transmit data;

For the specific contents of the above-mentioned “indication information of data attribute (or profile)” and “data transmission configuration information”, one can refer to the above-mentioned “data configuration information”.
Configuration information of the first node, such as CellGroupConfig information in TS38.331.

In step 2-b-2, the third node sends a fourth response message to the second node. The functions of the message include: confirming receipt of the second request message in step 2-b-1;

In step 2-b-3, the third node sends a fifth request message to the first node, or the third node sends a fifth request message to the first node through the fourth node, which is used to configure the first node to transmit data. For the content of the fifth request message, one can refer to the first request message in the above step 2-1.

In the above process, the fourth request message and the fourth response message can be F1AP messages (such as a UE Context Modification Required message and a UE Context Modification Confirm message) or other messages.

The process in above Method 2 can be used only for configuring transmission of control plane data (such as F1-C data), or can be used only for configuring transmission of user plane data, or can be used for configuring both transmission of the control plane data (such as F1-C data) and the user plane data.

Advantageous effects that can be achieved by the method 2 includes: enabling the second node to provide information about data transmission configuration to the third node according to actual situations, so that the transmission configuration performed by the third node can better conform to the actual situations of each related node.

Advantageous effects that can be achieved by the processes in the above methods 1 and 2 further includes: for example, the second node can generate configuration information required by the first node to transmit data, which can help configure the first node, and then the first node can perform transmission of data according to the configuration generated by the second node. In addition, it can help the second node determine resources for transmitting the data of the first node.

When the first node is in a dual connectivity, configuring the first node for data transmission also includes a signaling interaction process between the third node and the fourth node, thereby completing configuration of the first node for data transmission. Specifically, the process includes the following two methods.
Method 1: configuration initiated by the third node

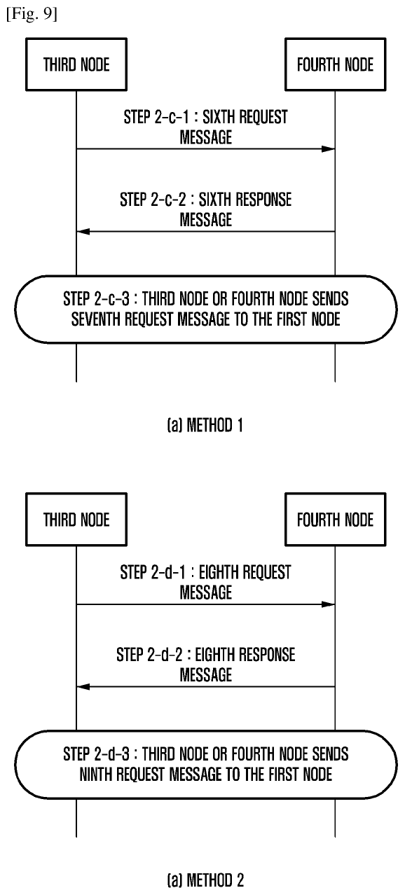

The method includes the following steps, as shown in FIG. 9(a):

In step 2-c-1, the third node sends a sixth request message to the fourth node for sending configuration information related to data transmission for the first node (the transmitted data may be data of the first node itself, data of the fifth node, or the data of the first node itself and the data of the fifth node). The sixth request message may include at least one of the following information:
configuration information related to data transmission for the first node, for the contents thereof, one can refer to the above-mentioned “data configuration information”.
indication information indicating the fourth node to transmit data, which is F1-C data in one embodiment.
indication information indicating the fourth node to transmit data of the first node, which is F1-C data in one embodiment.
indication information indicating the fourth node to transmit data of the fifth node, which is F1-C data in one embodiment.

In Step 2-c-2, optionally, the fourth node sends a sixth response message to the third node. The message includes at least one of the following functions: confirming the correct receipt of the sixth request message in step 2-c-1, and generating the configuration information related to data transmission for the first node, such as configuration information of SRB3 or the above-mentioned “data configuration information”.

Optionally, in step 2-c-3, the third node or the fourth node sends a seventh request message to the first node, and for the information contained in the message, one can refer to the first request message in the above step 2-1.

The sixth request message and the sixth response message in the above process can be XnAP messages (such as an S-Node Addition/Modification Request message and an S-Node Addition/Modification Request Acknowledge message, or an S-Node Modification Required message and an S-Node Modification Confirm message, respectively), or can also be X2AP messages (such as an SgNB Addition/Modification Request message and an SgNB Addition/Modification Request Acknowledge message, or an SgNB Modification Required message and an SgNB Modification Confirm message, respectively) or other messages.

The process in above Method 1 can be used only for configuring transmission of control plane data (such as F1-C data), or can be used only for configuring transmission of user plane data, or can be used for configuring both transmission of the control plane data (such as F1-C data) and the user plane data at the same time.

Advantageous effects that can be achieved by the method 1 includes: for example, the third node can collect information related to data transmission configuration according to needs, so as to help the third node to perform the transmission configuration more in line with the actual conditions of each related node, thereby increasing the communication efficiency.
Method 2: Configuration initiated by the fourth node

As a non-limiting example, for example, in the case where the fourth node is the master base station, the configuration may be initiated by the fourth node. The Method 2 includes the following steps, as shown in FIG. 9(b):

In step 2-d-1, the fourth node sends an eighth request message to the third node for sending configuration information related to data transmission for the first node (the transmitted data may be data of the first node itself, data of the fifth node, or the data of the first node itself and the data of the fifth node). The eighth request message includes at least one of the following information:
indication information of data attribute (or profile),
The data transmission configuration information, which includes at least one of:
indication information of a cell group, such as MCG, SCG, MCG and SCG (“both” can be used to indicate that both MCG and SCG can be used to transmit data),
indication information of a cell,
indication information of a transmission method, such as a RRC message (or a SRB), a backhaul link channel, a RRC message (or a SRB) and a backhaul link channel (“both” can be used to indicate that both a RRC message (or a SRB) and a backhaul link channel can be used to transmit data),
indication information of a transmission network, such as LTE network, 5G (or NR) network, LTE and 5G (or NR) network (“both” can be used to indicate that both LTE and 5G networks can be used to transmit data). In an embodiment, the transmission path indication information of F1-C (e.g., f1c-TransferPath) can be used to represent the above-mentioned “indication information of a transmission network”, and the network indicated by the information can be LTE, NR, or both (i.e., LTE and NR)
indication information to use LTE to transmit data;
indication information to use 5G or NR to transmit data;
indication information to use RRC or SRB to transmit data;
indication information to use a backhaul link channel to transmit data;
indication information to use MCG to transmit data;
indication information to use SCG to transmit data;

For the specific contents of the above-mentioned “indication information of data attribute (or profile)” and “data transmission configuration information”, one can refer to the above-mentioned “data configuration information”.

In step 2-d-2, the third node sends an eighth response message to the fourth node, and the function of the message includes at least one of the following functions: confirming receipt of the eighth request message in step 2-d-1, and sending data transmission configuration information related to the first node generated by the third node. For the content contained in the configuration information, one can refer to the above-mentioned “data configuration information”.

Optionally, in step 2-d-3, the fourth node (or the third node) sends a ninth request message to the first node, and for the content of the message, one can refer to the first request message in step 2-1 above.

The eighth request message and the eighth response message in the above process can be XnAP messages (such as an S-Node Addition/Modification Request message and an S-Node Addition/Modification Request Acknowledge message, or an S-Node Modification Required message and an S-Node Modification Confirm message, respectively), or can also be X2AP messages (such as an SgNB Addition/Modification Request message and an SgNB Addition/Modification Request Acknowledge message, or an SgNB Modification Required message and an SgNB Modification Confirm message, respectively) or other messages.

The process in the above Method 2 can be used only for configuring transmission of control plane data (such as F1-C data), or can be used only for configuring transmission of user plane data, or can be used for configuring both transmission of the control plane data (such as F1-C data) and the user plane data at the same time.

Advantageous effects that can be achieved by the method 2 include: for example, configuration information related to data transmission can be exchanged between nodes, so that the configuration of data transmission is more in line with actual situations of each related node, and thus the communication efficiency is optimized.

Advantageous effects that can be achieved by the processes in the above methods 1 and 2 further include: for example, the fourth node can generate configuration information needed to help the first node transmit data, and then the first node can transmit data with corresponding attribute (or profile) through the fourth node according to the configuration information.

The Third Aspect: The Transmission of User Plane Data During the Process of PSCell Change

When the relay node is in a dual connectivity, its PSCell (that is, a master cell served by a secondary base station) may change, which may be caused by the change of the secondary base station, or by the change of an upper level node serving the relay node, or by other reasons. The method of the present application does not limit the reasons for the change of PSCell.

During the process of PSCell change, in order to configure links from the first node to the third node, the required signaling interaction process will cause communication interruption between the first node and the third node, which will cause the interruption of data transmission of users accessing relay nodes. To solve this problem, the method given in the present application is: during the process of changing the PSCell (for example, the handover process), the relay node performs transmission of user plane data with the donor node to which it connects through the master base station.

The user plane data involved in this aspect include the following two types: the user plane data of the first node and user plane data of the fifth node.

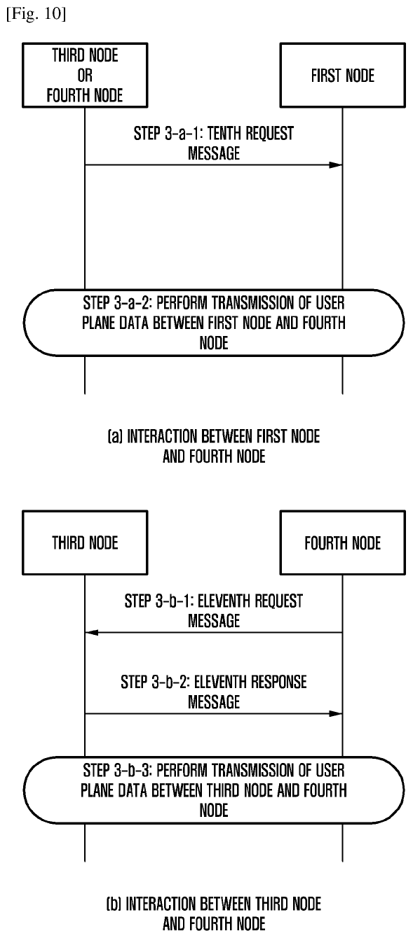

In order to realize this method, the present application includes an interaction process as shown in FIG. 10. FIG. 10 illustrates an example process of configuring a first node (e.g., a relay node) to perform user plane data transmission with a third node (e.g., an donor node) to which it connects through a fourth node (e.g., a master base station) in a scenario where a PSCell changes (e.g., an upper level node serving the first node changes). It should be understood that the process shown in FIG. 10 occurs during a handover process when the PSCell changes, and description of the handover process is omitted to avoid obscuring the focus of this disclosure.

1. Transmission of the User Plane Data Between the Relay Node and the Master Base Station

The method includes the following signaling interaction process, as shown in FIG. 10(a):

In step 3-a-1, the third node or the fourth node sends a tenth request message to the first node, which is used to configure the first node to perform user plane data transmission with the fourth node. In order to transmit user plane data, one or more radio bearers need to be established between the fourth node and the first node. In one embodiment, the radio bearer is used to transmit user plane data of the first node, and in another embodiment, the radio bearer is used to transmit user plane data of the fifth node. For each radio bearer, the tenth request message includes at least one of the following information:
identification information of the radio bearer;
configuration information of user plane data carried by the radio bearer, which includes at least one of:
information on a uplink tunnel, which includes at least one of an IP address of a third node side and a tunnel endpoint identifier,
information on a downlink tunnel, which includes at least one of an IP address of a first node side and a tunnel endpoint identifier,
source address information, such as an IP address and/or a BAP address, etc.,
destination address information, such as an IP address and/or a BAP address, etc.,
routing identification information, such as a BAP routing ID, in one embodiment, it includes a BAP address of a destination receiving node and path identification information,
path identification information, such as a path ID
information of a backhaul link channel used for user plane data, the backhaul link channel is a backhaul link channel used by the first node to transmit the user plane data, and the information includes at least one of:
identification information of a backhaul link channel used for sending the user plane data, such as Egress BH RLC CH ID, which may be identification information of one or more channels, and further may include identification information of a next-hop node serving the backhaul link channel, such as BAP addresses,
identification information of a backhaul link channel used for receiving the user plane data, such as Ingress BH RLC CH ID, which may be identification information of one or more channels, and further may include identification information of a prior-hop node serving the backhaul link channel, such as BAP addresses.

As a non-limiting example, for example, the tenth request message mentioned above can be carried in the handover command, and the following other messages can be similarly transmitted in the commands or messages related to the handover process, which will not be described again below, so as not to obscure the focus of the present application.

In step 3-a-2, the user plane data is transmitted between the first node and the fourth node according to the configuration. This step may also be an independent step, that is, it is not necessary to perform this step after performing step 3-a-1. In this step, if signaling radio bearer is used to send user plane data, in one embodiment, it is necessary to define a new RRC message or a new container in the existing RRC message. The new RRC message or the new container in the existing RRC message contains user plane data. Specifically, the fourth node sends the new RRC message or the existing RRC message to the first node (or the first node to the fourth node), and the message can be expressed as a twelfth request message, which contains at least one of the following information:
user plane data, such as the above-mentioned “user plane data of the first node” and/or “user plane data of the fifth node”
indication information related to a transmission route, which includes at least one of the following information:
routing identification information, which indicates routing identification used for transmitting user plane data, such as a BAP routing ID, which contains a BAP address of the destination receiving node and path identification information
BAP address information, which is the BAP address of the destination receiving node
Path identification information, the path is a path used to send user plane data to the destination receiving node
indication information related to a transmission channel, which includes at least one of:
identification information of a backhaul link channel used for sending user plane data, such as Egress BH RLC CH ID, which may be identification information of one or more channels which will be used by the first node to send the user plane data out after receiving this information, and the identification information may further include identification information of a next-hop node serving the backhaul link channel, such as BAP addresses
identification information of a backhaul link channel used for receiving the user plane data, such as Ingress BH RLC CH ID, which may be identification information of one or more channels, and further may include identification information of a prior-hop node serving the backhaul link channel, such as BAP addresses.

After receiving the “indication information related to a transmission channel”, the first node needs to transmit data according to the backhaul link channel indicated by the information.
information related to the transmission route to be added, which includes at least one of the following information:
routing identification information, which indicates routing identification used for transmitting user plane data, such as a BAP routing ID, which contains a BAP address of the destination receiving node and path identification information
BAP address information, which is the BAP address of the destination receiving node
Path identification information, the path is a path used to send user plane data to the destination receiving node

After receiving the “information related to the transmission route to be added”, the first node needs to add one or more of the above information indicated by it to the user plane packet.

In the above process, the radio bearer established by step 3-a-1 may be a data radio bearer (DRB), a signaling radio bearer (a SRB), or a new radio bearer (such as a radio bearer different from a DRB and a SRB, it is necessary to add a PDCP header to data when transmitting the data using this radio bearer. In another embodiment, it is not necessary to add a PDCP header to packets transmitted using this radio bearer (or other newly defined names)). In addition, in one embodiment, all user plane data can be transmitted in a same radio bearer, or different radio bearers can be established for different user plane data and then transmitting data by different radio bearers.

The above tenth request message can be a RRC message (such as a RRCReconfiguration message), an F1AP message, or other messages.

Advantageous effects that can be achieved by the above process include: for example, during the handover process, a path for sending user plane data is quickly established between the relay node and the base station, thereby reducing data transmission delay, reducing the possibility of communication interruption, and further improving the user experience and optimizing the communication environment.

2. Transmission of the User Plane Data Between the Master Base Station and the Donor Node

The method includes the following signaling interaction process, as shown in FIG. 10(b):

In step 3-b-1, the fourth node sends an eleventh request message to the third node. The function of the message is to configure the data transmission of the user plane. The message includes at least one of the following information:
identification information of a radio bearer, in one embodiment, the radio bearer may be a radio bearer used by the fourth node to transmit user plane data with the first node.
configuration information of tunnels used by the fourth node side for receiving user plane data, and functions of the tunnels are for receiving user plane data sent by the third node to the fourth node. There may be one or more tunnels, and for each tunnel, the information includes at least one of the following information:
an IP address of the fourth node side,
tunnel endpoint identifier,

In step 3-b-2, optionally, the third node sends an eleventh response message to the fourth node. The function of the message is to configure transmission of the user plane data. The message includes at least one of the following information:
identification information of a radio bearer, in one embodiment, the radio bearer may be a radio bearer used by the fourth node to transmit user plane data with the first node
configuration information of tunnels used by the third node side for receiving user plane data, and functions of the tunnels are for receiving user plane data sent by the fourth node to the third node. There may be one or more tunnels, and for each tunnel, the information includes at least one of the following information:
an IP address of the third node side,
tunnel endpoint identifier,
indication information related to a transmission route, which is a transmission route of user plane data, the indication information includes at least one of the following information:
routing identification information, which indicates routing identification used for transmitting user plane data, such as a BAP routing ID, which contains a BAP address of the destination receiving node and path identification information
BAP address information, which is the BAP address of the destination receiving node
path identification information, the path is a path used to send user plane data to the destination receiving node
indication information related to a transmission channel, which is a transmission channel of user plane data, the indication information includes at least one of the following information:
identification information of a backhaul link channel used for sending user plane data, such as Egress BH RLC CH ID, which may be identification information of one or more channels which will be used by the first node to send the user plane data out after receiving this information, and the identification information may further include identification information of a next-hop node serving the backhaul link channel such as BAP addresses
identification information of a backhaul link channel used for receiving the user plane data, such as Ingress BH RLC CH ID, which may be identification information of one or more channels, and the identification information may further include identification information of a prior-hop node serving the backhaul link channel, such as BAP addresses.

In step 3-b-3, the user plane data is transmitted between the third node and the fourth node. This step may also be an independent step, that is, it is not necessary to perform this step after performing steps 3-b-1, 3-b-2. In one embodiment, the user plane data can be sent through the tunnel information exchanged in steps 3-b-1 and 3-b-2. In another embodiment, the user plane data can be sent through a new control message defined between the third node and the fourth node (such as a new control message sent by the third node to the fourth node or a new control message sent by the fourth node to the third node). The new control message can be expressed as a thirteenth request message, which includes at least one of the following information:
data of user plane, such as the above-mentioned “user plane data of the first node” and/or “user plane data of the fifth node”
indication information related to a transmission route, which includes at least one of the following information:
routing identification information, which indicates routing identification used for transmitting user plane data, such as a BAP routing ID, which contains a BAP address of the destination receiving node and path identification information
BAP address information, which is the BAP address of the destination receiving node
path identification information, the path is a path used to send user plane data to the destination receiving node
indication information related to a transmission channel, which includes at least one of:
identification information of a backhaul link channel used for sending user plane data, such as Egress BH RLC CH ID, which may be identification information of one or more channels which will be used by the first node to send the user plane data out after receiving this information, and the identification information may further include identification information of a next-hop node serving the backhaul link channel such as BAP addresses
identification information of a backhaul link channel used for receiving the user plane data, such as Ingress BH RLC CH ID, which may be identification information of one or more channels, and may further include identification information of a prior-hop node serving the backhaul link channel, such as BAP addresses.

After receiving the “indication information related to a transmission channel”, the first node needs to transmit data according to a backhaul link channel indicated by the information.

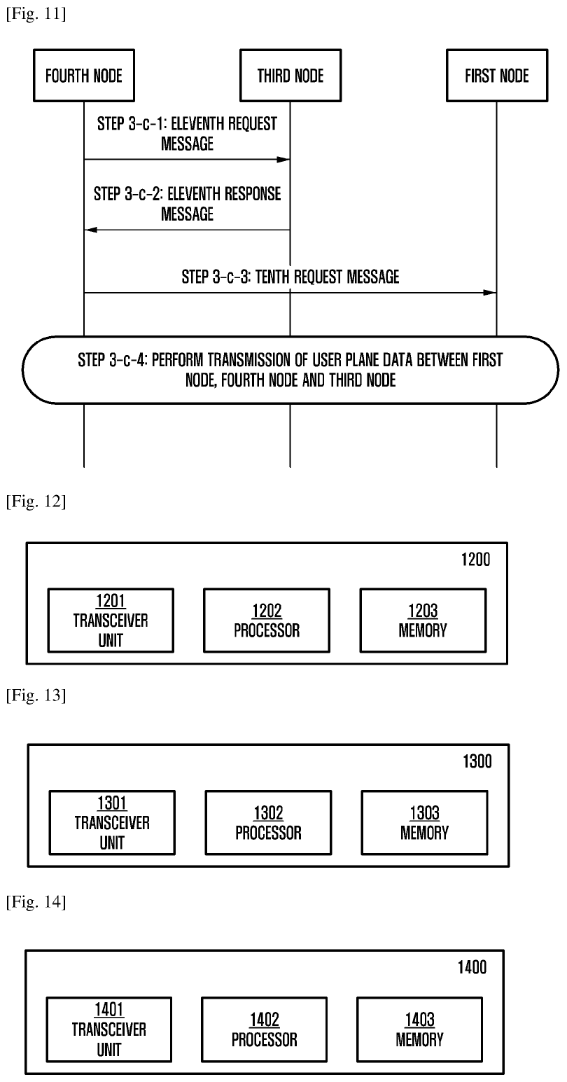

The above signaling interaction processes can also be combined with each other, as shown in FIG. 11, which includes the following steps:
In step 3-c-1, the fourth node sends an eleventh request message to the third node. For the specific contents of the message, one can refer to the above step 3-b-1;
In step 3-c-2, the third node sends an eleventh response message to the fourth node, and for the specific contents of the message, one can refer to the above step 3-b-2;
In step 3-c-3, the fourth node sends a tenth request message to the first node, and for the specific contents of the message, one can refer to the above step 3-a-1;
In step 3-c-4, transmission of user plane data is performed among the first node, the fourth node and the third node. Herein, for the transmission of the user plane data between the first node and the fourth node, one can refer to the above step 3-a-2, and for the user plane data transmission between the fourth node and the third node, one can refer to the above step 3-b-3.

The above eleventh request message and the eleventh response message can be X2AP or XnAP messages, respectively, or other messages.

The above thirteenth request message can be an X2AP or XnAP message or other messages.

Advantageous effects that can be achieved by the above process include: when the PSCell changes, the user plane data between the relay node and the donor node can be transmitted through other nodes (such as the master base station), thereby reducing the adverse effects caused by the interruption of user plane data transmission.

Advantageous effects that can be achieved by the present application include: the relay node can select an appropriate way to transmit its own data and the data of its child nodes according to the configuration, so that the reliability of data can be improved, the delay of data transmission can be reduced, and the throughput of data transmission can be increased.

In addition, advantageous effects that can be achieved by the present application further include: when the PSCell serving the relay node changes, the user plane data of the relay node can be continuously transmitted through the master base station, thereby avoiding the interruption of the transmission of the user plane data.

FIG. 12 illustrates a simplified block diagram of an example configuration of hardware components of a communication device 1200 according to various embodiments of the present disclosure, and the communication device may implement the method of the first node according to various embodiments of the present disclosure.

As shown in FIG. 12, the communication device 1200 includes a transceiver unit 1201, a processor 1202 and a memory 1203.

The transceiver unit 1201 is configured to receive and/or transmit signals.

The processor 1202 is operatively connected to the transceiver unit 1201 and the memory 1203. The processor 1202 may be implemented as one or more processors for operating according to the method of the first node described in various embodiments of the present disclosure.

The memory 1203 is configured to store data. The memory 1203 may include a non-transitory memory for storing operations and/or code instructions executable by the processor 1202. The memory 1203 may include processor readable non-transitory instructions that, when executed, cause the processor 1202 to implement the steps of the method of the first node according to various embodiments of the present disclosure. The memory 1203 may also include random access memory or buffer(s) to store intermediate processing data from various functions performed by the processor 1202.

FIG. 13 illustrates a simplified block diagram of an example configuration of hardware components of a communication device 1300 according to various embodiments of the present disclosure, and the communication device may implement the method of the third node according to various embodiments of the present disclosure.

As shown in FIG. 13, the communication device 1300 includes a transceiver unit 1301, a processor 1302 and a memory 1303.

The transceiver unit 1301 is configured to receive and/or transmit signals.

The processor 1302 is operatively connected to the transceiver unit 1301 and the memory 1303. The processor 1302 may be implemented as one or more processors for operating according to the method of the third node described in various embodiments of the present disclosure.

The memory 1303 is configured to store data. The memory 1303 may include a non-transitory memory for storing operations and/or code instructions executable by the processor 1302. The memory 1303 may include processor readable non-transitory instructions that, when executed, cause the processor 1302 to implement the steps of the method of the third node according to various embodiments of the present disclosure.

The memory 1303 may also include random access memory or buffer(s) to store intermediate processing data from various functions performed by the processor 1302.

FIG. 14 illustrates a simplified block diagram of an example configuration of hardware components of a communication device 1400 according to various embodiments of the present disclosure, and the communication device may implement the method of the fourth node according to various embodiments of the present disclosure.

As shown in FIG. 14, the communication device 1400 includes a transceiver unit 1401, a processor 1402 and a memory 1403.

The transceiver unit 1401 is configured to receive and/or transmit signals.

The processor 1402 is operatively connected to the transceiver unit 1401 and the memory 1403. The processor 1402 may be implemented as one or more processors for operating according to the method of the fourth node described in various embodiments of the present disclosure.

The memory 1403 is configured to store data. The memory 1403 may include a non-transitory memory for storing operations and/or code instructions executable by the processor 1402. The memory 1403 may include processor readable non-transitory instructions that, when executed, cause the processor 1402 to implement the steps of the method of the fourth node according to various embodiments of the present disclosure. The memory 1403 may also include random access memory or buffer(s) to store intermediate processing data from various functions performed by the processor 1402.

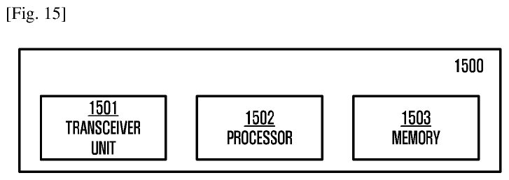

FIG. 15 illustrates a simplified block diagram of an example configuration of hardware components of a communication device 1500 according to various embodiments of the present disclosure, and the communication device may implement the method of the second node according to various embodiments of the present disclosure.

As shown in FIG. 15, the communication device 1500 includes a transceiver unit 1501, a processor 1502 and a memory 1503.

The transceiver unit 1501 is configured to receive and/or transmit signals.

The processor 1502 is operatively connected to the transceiver unit 1501 and the memory 1503. The processor 1502 may be implemented as one or more processors for operating according to the method of the second node described in various embodiments of the present disclosure.

The memory 1503 is configured to store data. The memory 1503 may include a non-transitory memory for storing operations and/or code instructions executable by the processor 1502. The memory 1503 may include processor readable non-transitory instructions that, when executed, cause the processor 1502 to implement the steps of the method of the second node according to various embodiments of the present disclosure. The memory 1503 may also include random access memory or buffer(s) to store intermediate processing data from various functions performed by the processor 1502.

Those of ordinary skill in the art will recognize that the description of packet transmission mechanism and device is illustrative only and is not intended to be limiting in any way. Other embodiments will readily occur to those of ordinary skill in the art having the benefit of this disclosure.

For the sake of clarity, all conventional features of embodiments of the packet transmission mechanism and device have not been illustrated and described. Of course, it should be understood that in the development of any such actual implementation of the packet transmission mechanism and device, in order to achieve the specific goals of developers, such as conforming to constraints related to applications, systems, networks and businesses, many implementation-specific decisions may need to be made, and these specific goals will change with different implementations and different developers.

The modules, processing operations and/or data structures described according to the present disclosure may be implemented using various types of operating systems, computing platforms, network devices, computer programs and/or general-purpose machines. In addition, those of ordinary skill in the art will recognize that less general devices, such as hardwired devices, Field Programmable Gate Array (FPGA), application specific integrated circuits (ASIC), etc., may also be used. In a case that a method including a series of operations and sub-operations is implemented by a processor, a computer or a machine, and those operations and sub-operations may be stored as a series of non-transitory code instructions readable by the processor, the computer or the machine, they may be stored on tangible and/or non-transient medium.

The modules of the packet transmission mechanism and device described herein may include software, firmware, hardware or any combination(s) of software, firmware or hardware suitable for the purposes described herein.

In the packet transmission mechanism described herein, various operations and sub-operations may be performed in various orders, and some of the operations and sub-operations may be optional.

Although the foregoing disclosure of the present application has been made by non-limiting illustrative embodiments, these embodiments may be arbitrarily modified within the scope of the appended claims without departing from the spirit and essence of the disclosure.

### INDUSTRIAL APPLICABILITY

The present disclosure can be applied to a system in which one node is connected to different upper nodes to transmit packet data.

1-15. (canceled)

16. A method for transmitting data by a central unit (CU) of a first base station in a communication system, the method comprising:
transmitting, to a distributed unit (DU) of the first base station, a first request message including information indicating a transmission path of F1-C traffic;
receiving, from the DU of the first base station, a first response message in response to the first request message; and
transmitting, to a user equipment (UE), a configuration message including the information indicating the transmission path of the F1-C traffic.

17. The method of claim 16, wherein the information indicating the transmission path of the F1-C traffic indicates one of long term evolution (LTE), new radio (NR), or both LTE and NR as the transfer path of the F1-C traffic in evolved-universal terrestrial radio access-NR dual connectivity (EN-DC).

18. The method of claim 16, wherein the information indicating transmission path of a F1-C traffic indicates one of a master cell group (MCG), a secondary cell group (SCG), or both the MCG and the SCG as the transfer path of the F1-C traffic in new radio (NR)-dual connectivity (DC).

19. The method of claim 16, further comprising:
transmitting, to a CU of a second base station, a second request message to provide configuration information of the F1-C traffic; and
receiving, from the CU of the second base station, a second response message including information for the F1-C traffic.

20. A method for transmitting data by a distributed unit (DU) of a first base station in a communication system, the method comprising:
receiving, from a central unit (CU) of the first base station, a first request message including information indicating a transmission path of F1-C traffic;
transmitting, to the CU of the first base station, a first response message in response to the first request message; and
transmitting a configuration message including the information indicating the transmission path of the F1-C traffic is transmitted to a user equipment (UE).

21. The method of claim 20, wherein the information indicating the transmission path of the F1-C traffic indicates one of long term evolution (LTE), new radio (NR), or both LTE and NR as the transfer path of the F1-C traffic in evolved-universal terrestrial radio access-NR dual connectivity (EN-DC).

22. The method of claim 20, wherein the information indicating the transmission path of the F1-C traffic indicates one of a master cell group (MCG), a secondary cell group (SCG), or both the MCG and the SCG as the transfer path of the F1-C traffic in new radio (NR)-dual connectivity (DC).

23. A central unit (CU) of a first base station in a communication system, the CU comprising:
a transceiver; and
a controller configured to:
transmit, to a distributed unit (DU) of the first base station, a first request message including information indicating a transmission path of F1-C traffic,
receive, from the DU of the first base station, a first response message in response to the first request message, and
transmit, to a user equipment (UE), a configuration message including the information indicating the transmission path of the F1-C traffic.

24. The CU of claim 23, wherein the information indicating the transmission path of the F1-C traffic indicates one of long term evolution (LTE), new radio (NR), or both LTE and NR as the transfer path of the F1-C traffic in evolved-universal terrestrial radio access-NR dual connectivity (EN-DC).

25. The CU of claim 23, wherein the information indicating the transmission path of the F1-C traffic indicates one of a master cell group (MCG), a secondary cell group (SCG), or both the MCG and the SCG as the transfer path of the F1-C traffic in new radio (NR)-dual connectivity (DC).

26. A distributed unit (DU) of a first base station in a communication system, the DU comprising:
a transceiver; and
a controller configured to:
receive, from a central unit (CU) of the first base station, a first request message including information indicating a transmission path of F1-C traffic;
transmit, to the CU of the first base station, a first response message in response to the first request message; and
transmit a configuration message including the information indicating the transmission path of the F1-C traffic is transmitted to a user equipment (UE).

27. The DU of claim 26, wherein the information indicating the transmission path of the F1-C traffic indicates one of long term evolution (LTE), new radio (NR), or both LTE and NR as the transfer path of the F1-C traffic in evolved-universal terrestrial radio access-NR dual connectivity (EN-DC).

28. The DU of claim 26, wherein the information indicating the transmission path of the F1-C traffic indicates one of a master cell group (MCG), a secondary cell group (SCG), or both the MCG and the SCG as the transfer path of the F1-C traffic in new radio (NR)-dual connectivity (DC).
